(19) United States
(12) Patent Application Publication
(10) Pub. No.: US 2016/0241575 A1
(43) Pub. Date: Aug. 18, 2016

(54) INFORMATION PROCESSING SYSTEM AND INFORMATION PROCESSING METHOD

(71) Applicant: FUJITSU LIMITED, Kawasaki-shi (JP)

(72) Inventors: Mebae USHIDA, Kawasaki (JP); Masahiko TAKENAKA, Kawasaki (JP)

(73) Assignee: FUJITSU LIMITED, Kawasaki-shi (JP)

(21) Appl. No.: 14/976,507

(22) Filed: Dec. 21, 2015

(30) Foreign Application Priority Data
Feb. 12, 2015 (JP) 2015-024964

(51) Int. Cl. H04L 29/06; H04L 12/58

(52) U.S. Cl. CPC H04L 63/1416; H04L 51/12; H04L 63/145

(57) ABSTRACT

An information processing system includes circuitry configured to request a mail server to provide mail data addressed to a user, extract link data included in the mail data obtained from the mail server, generate a list related to security of an access destination indicated by the link data, receive an access request to the access destination, from a communication device that receives the mail data from the mail server, determine whether the access destination is safe based on the list and the access request, and transmit an alert regarding the security that the access destination is not safe.

### CROSS-REFERENCE TO RELATED APPLICATION

This application is based upon and claims the benefit of priority of the prior Japanese Patent Application No. 2015-024964, filed on Feb. 12, 2015, the entire contents of which are incorporated herein by reference.

### FIELD

The embodiments discussed herein are related to a technology by which access induction by a link is suppressed.

### BACKGROUND

For example, a mail to which a Uniform Resource Locator (URL) of a malicious website that dispatches malware has been inserted is sometimes sent to a user terminal (communication device). In addition, when the user terminal accesses the URL, the user terminal is infected with the malware.

As measures to avoid the infection with malware, usage of a site that provides service for inspecting URL is considered. In this case, when the site is queried about a specified URL, a user may know whether the URL is malicious. A technology in a related art is discussed, for example, in Japanese Laid-open Patent Publication No. 11-149405 and Japanese Laid-open Patent Publication No. 2013-191133.

### SUMMARY

According to an aspect of the invention, an information processing system includes circuitry configured to request a mail server to provide mail data addressed to a user, extract link data included in the mail data obtained from the mail server, generate a list related to security of an access destination indicated by the link data, receive an access request to the access destination, from a communication device that receives the mail data from the mail server, determine whether the access destination is safe based on the list and the access request, and transmit an alert regarding the security that the access destination is not safe.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first example of a network configuration;

FIG. 2 is a diagram illustrating a second example of a network configuration;

FIG. 3 is a diagram illustrating a sequence example of a checking phase;

FIG. 4 is a diagram illustrating a sequence example of a relay phase;

FIG. 5 is a diagram illustrating a sequence example of a checking phase;

FIG. 6 is a diagram illustrating a sequence example of a relay phase;

FIG. 7 is a diagram illustrating a module configuration example of a proxy server;

FIG. 8 is a diagram illustrating a module configuration example of a checking unit;

FIG. 9 is a diagram illustrating an example of a checking processing flow;

FIG. 10 is a diagram illustrating a module configuration example of a relay unit;

FIG. 11 is a diagram illustrating an example of a relay processing flow;

FIG. 12 is a diagram illustrating a module configuration example of a mail server;

FIG. 13 is a diagram illustrating an example of a disclosure processing flow;

FIG. 14 is a diagram illustrating an example of a delivery processing flow;

FIG. 15 is a diagram illustrating a third example of a network configuration;

FIG. 16 is a diagram illustrating a sequence example of a checking phase in a second embodiment;

FIG. 17 is a diagram illustrating a sequence example of a checking phase in the second embodiment;

FIG. 18 is a diagram illustrating a module configuration example in a checking unit according to the second embodiment;

FIG. 19 is a diagram illustrating an example of a checking processing flow in the second embodiment;

FIG. 20 is a diagram illustrating a sequence example of a checking phase in a third embodiment;

FIG. 21 is a diagram illustrating a sequence example of a relay phase according to the third embodiment;

FIG. 22 is a diagram illustrating a sequence example of a relay phase according to the third embodiment;

FIG. 23 is a diagram illustrating a module configuration example of a proxy server according to the third embodiment;

FIG. 24 is a diagram illustrating a module configuration example of a checking unit according to the third embodiment;

FIG. 25 is a diagram illustrating an example of cache data;

FIG. 26 is a diagram illustrating an example of a checking processing flow in the third embodiment;

FIG. 27 is a diagram illustrating a module configuration example of a relay unit according to the third embodiment;

FIG. 28 is a diagram illustrating an example of a relay processing flow in the third embodiment;

FIG. 29 is a diagram illustrating a sequence example of a checking phase in a fourth embodiment;

FIG. 30 is a diagram illustrating a sequence example of a relay phase in the fourth embodiment;

FIG. 31 is a diagram illustrating a sequence example of a relay phase in the fourth embodiment;

FIG. 32 is a diagram illustrating a sequence example of a relay phase in the fourth embodiment;

FIG. 33 is a diagram illustrating a module configuration example of a checking unit according to the fourth embodiment;

FIG. 34 is diagram illustrating an example of cache data in the fourth embodiment;

FIG. 35 is a diagram illustrating an example of a checking processing flow in the fourth embodiment;

FIG. 36 is a diagram illustrating a module configuration example of a relay unit according to the fourth embodiment;

FIG. 37 is a diagram illustrating an example of a relay processing flow in the fourth embodiment;

FIG. 38 is diagram illustrating the example of the relay processing flow in the fourth embodiment; and

FIG. 39 is a functional block diagram of a computer.

### DESCRIPTION OF EMBODIMENTS

A user who is lacking security awareness may neglect inspection of URL.

An object of an embodiment is to automatically determine that a link destination to be accessed is a pernicious resource.

### First Embodiment

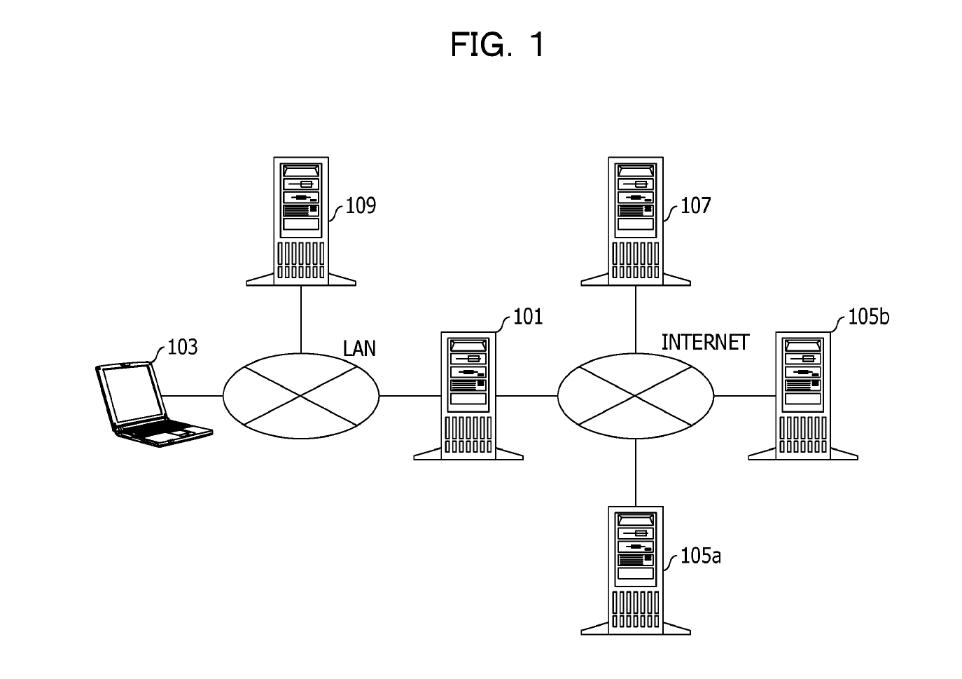

FIG. 1 illustrates a first example of a network configuration. A local area network (LAN) corresponds to, for example, a corporate network. The LAN is coupled to the Internet through a proxy server 101. The proxy server 101 acts for an access to the Internet from a user terminal 103 in the LAN. That is, the proxy server 101 relays an access request transmitted from the user terminal 103 to a web server 105 on the Internet, and relays an access result sent back from the web server 105 to the user terminal 103. The access request is, for example, a hypertext transfer protocol (HTTP) request. The access result is, for example, an HTTP response.

There are some web servers 105 on the Internet, which are malicious for the user. The malicious web server 105 dispatches malware, for example, to a device that has originated an access request. In FIG. 1, it is assumed that a web server 105a is malicious. In addition, it is assumed that a web server 105b is not malicious, that is, the web server 105b is safe.

An inspection server 107 coupled to the Internet inspects whether a web server 105 is malicious or safe, based on URL indicating the web server 105. The inspection server 107 determines danger of the web server 105, for example, based on a behavior of the web server 105 when the inspection server 107 accesses the web server 105. Alternatively, the inspection server 107 may store URL indicating a malicious web server 105 in advance, and determine that URL is malicious when the URL is matched with the stored URL.

In addition, a person who tries to induce a user to the malicious web server 105a may send a mail to the user. In the embodiment, the mail addressed to the user who uses the user terminal 103 is temporarily stored in a mail server 109 provided on the LAN. The user operates a mailer of the user terminal 103 to receive the email from the mail server 109. The user terminal 103 in this example includes an operating system, the mailer, and a browser.

For example, in a case in which URL indicating the malicious web server 105a is inserted into the body of mail data that has been received in the user terminal 103, when access to the malicious web server 105a is performed through the URL, the user terminal 103 may be infected with malware. As described above, for example, the description of URL in the mail body may be referred to as insertion of URL. An operation in which the browser is called through the operating system, and a content that has been obtained from an access destination is displayed on the browser when the URL of the mail body is clicked, is performed with a technology of a hyperlink in the related art.

In the embodiment, before mail data is received at the user terminal 103, the proxy server 101 checks mails accumulated in the mail server 109. In addition, the proxy server 101 records pieces of malicious URL to a blacklist. After that, when an access request originated from the user terminal 103 is relayed, the proxy server 101 determines an access request to malicious URL, and rejects transfer of the access request.

In the case of the network configuration illustrated in FIG. 1, the proxy server 101 obtains an inspection result of danger of URL, using the inspection server 107 provided on the Internet.

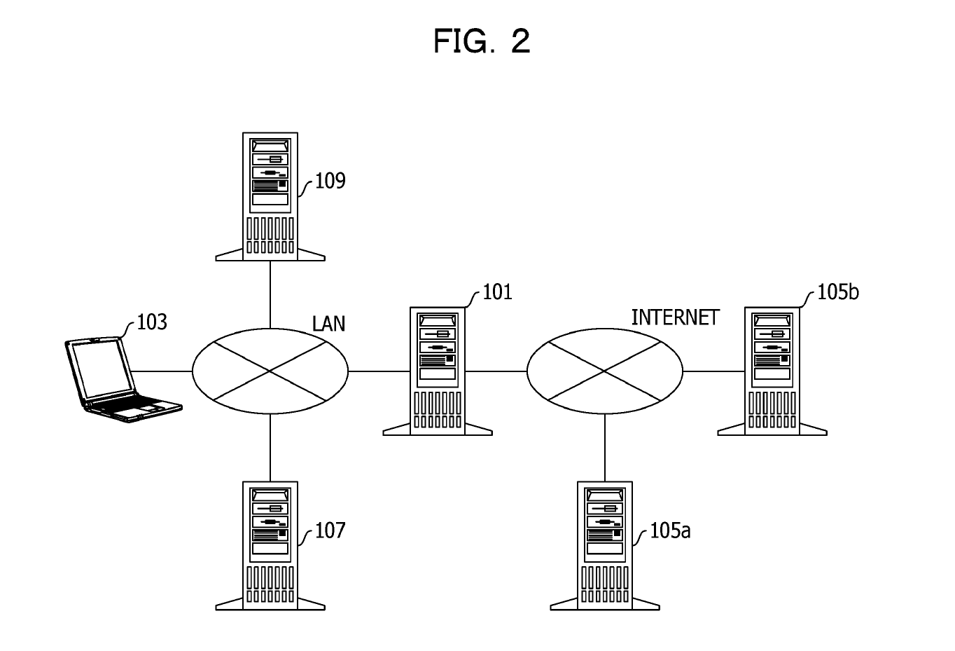

FIG. 2 illustrates a further network configuration example. In such an example, the inspection server 107 is provided on the LAN. In such a network configuration, the proxy server 101 obtains an inspection result of danger of URL, using the inspection server 107 provided on the LAN.

Due to malware with which the user terminal 103 is infected, for example, it is probable that data stored in the user terminal 103 is stolen or falsified. However, a web server 105 that is undesirable for the user is not limited to such a web server that dispatches malware. For example, a web server 105 that provides a content for the purpose of fraud or fraudulent solicitation and a content including further harmful information is also undesirable for the user. The proxy server 101 may use the inspection server 107 that inspects such pernicious. For example, when an access result includes a certain keyword, the inspection server 107 determines that URL corresponding to a source of the access result has pernicious. The inspection for danger of URL in such an example is an example of inspection for pernicious of URL. Thus, the proxy server 101 may operate so that “malicious” described in the following example is replaced with “pernicious”, and “safe” in the following example is replaced with “benign”.

A sequence in the embodiment is described later. First, a checking phase and a relay phase when URL of a malicious web server 105a (example of malicious URL) inserted into a mail are described. In the checking phase described below, a newly arrived mail is checked in advance. In the relay phase, a malicious access request transmitted from the user terminal 103 is rejected. However, when the access request is safe, the access request is relayed successfully.

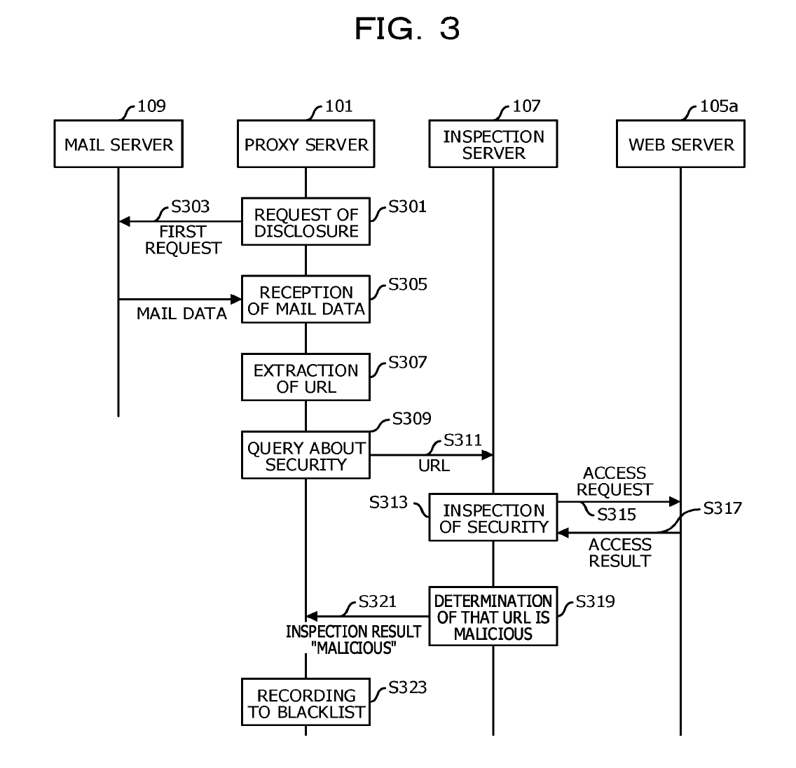

FIG. 3 illustrates a sequence example of a checking phase when malicious URL is inserted into a mail. The proxy server 101 requests disclosure of mail data to the mail server 109 (S301). The request transmitted from the proxy server 101 to the mail server 109 at this time is referred to as a first request. For example, the first request includes data used to authenticate the proxy server 101. The proxy server 101 may further include data used to identify the user (for example, a mail address or a user ID), in the first request.

When the mail server 109 receives the first request from the proxy server 101 (S303), the mail server 109 authenticates the proxy server 101. When the authentication of the proxy server 101 has been performed successfully, the mail server 109 extracts newly arrived mail data and transmits the mail data to the proxy server 101. The newly arrived mail data is mail data that is yet to be transmitted to the proxy server 101. When the first request includes data used to identify the user, the mail server 109 may extract mail data addressed to the user from among pieces of newly arrived mail data, and transmit the extracted mail data to the proxy server 101.

The proxy server 101 receives the mail data from the mail server 109 (S305). The proxy server 101 extracts URL from the mail data (S307). For example, the proxy server 101 searches for a character string of “http:” included in the mail body, and extracts the URL from the character string.

The proxy server 101 queries the inspection server 107 about security for the URL (S309). At this time, the URL that is an inspection target is transmitted from the proxy server 101 to the inspection server 107 (S311).

The inspection server 107 inspects security for the URL (S313). For example, the inspection server 107 transmits an access request to the web server 105a indicated by the URL (S315), and receives an access result from the web server 105a (S317). The inspection server 107 determines whether there is a possibility that the web server 105a dispatches malware, based on a behavior of the web server 105a at this time. When there is a possibility that the web server 105a dispatches malware, the inspection server 107 determines that an access to the resource indicated by the URL is malicious.

The access in such an example is an access to the web server 105a, so that the inspection server 107 determines that the URL that is the inspection target is malicious (S319). When the inspection server 107 determines that the URL that is the inspection target is malicious, the inspection server 107 transmits an inspection result indicating “malicious” to the proxy server 101 (S321).

When the proxy server 101 receives the inspection result indicating “malicious”, from the inspection server 107, the proxy server 101 records the URL that has been determined to be malicious, to the blacklist (S323).

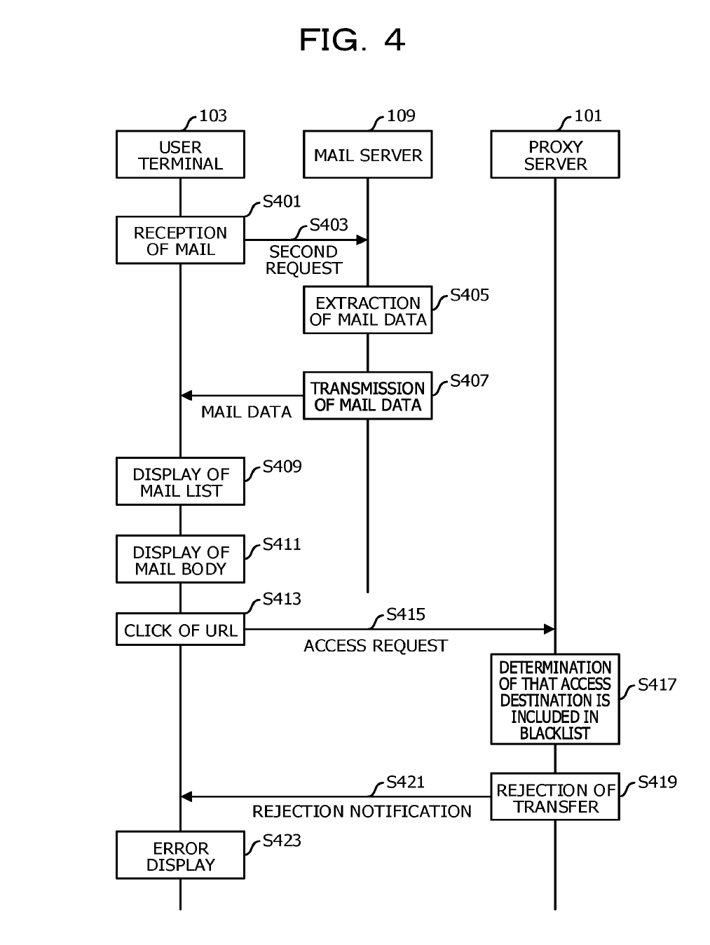

FIG. 4 illustrates a sequence example of a relay phase when transmission of an access request in which malicious URL is an access destination is performed. The user terminal 103 receives a mail addressed to the user, from the mail server 109 (S401). A request transmitted from the user terminal 103 to the mail server 109 is referred to as a second request. The second request includes, for example, account data used to identify the user.

When the mail server 109 receives the second request (S403), the mail server 109 extracts mail data addressed to the user, based on the account data included in the second request (S405). In addition, the mail server 109 transmits the extracted mail data to the user terminal 103 (S407).

When the user terminal 103 receives the mail data, for example, the user terminal 103 displays a mail list in which titles of the mails are arranged (S409). In addition, when the user performs an operation to select one of the titles, the user terminal 103 displays the mail body (S411). At this time, when the user clicks URL included in the displayed mail body (S413), an access request is transmitted from the user terminal 103 to the proxy server 101 (S415). The access request includes the URL corresponding to the access destination.

When the proxy server 101 determines whether the URL corresponding to the access destination is included in the blacklist, in response to the access request. The proxy server 101 determines that the URL corresponding to the access destination is included in the blacklist (S417), the proxy server 101 rejects transfer of the access request (S419). Thus, the access request is not relayed. In addition, the proxy server 101 transmits rejection notification to the user terminal 103 (S421).

When the user terminal 103 receives the rejection notification, the user terminal 103 displays an error indicating that the requested access to the URL has been rejected (S423).

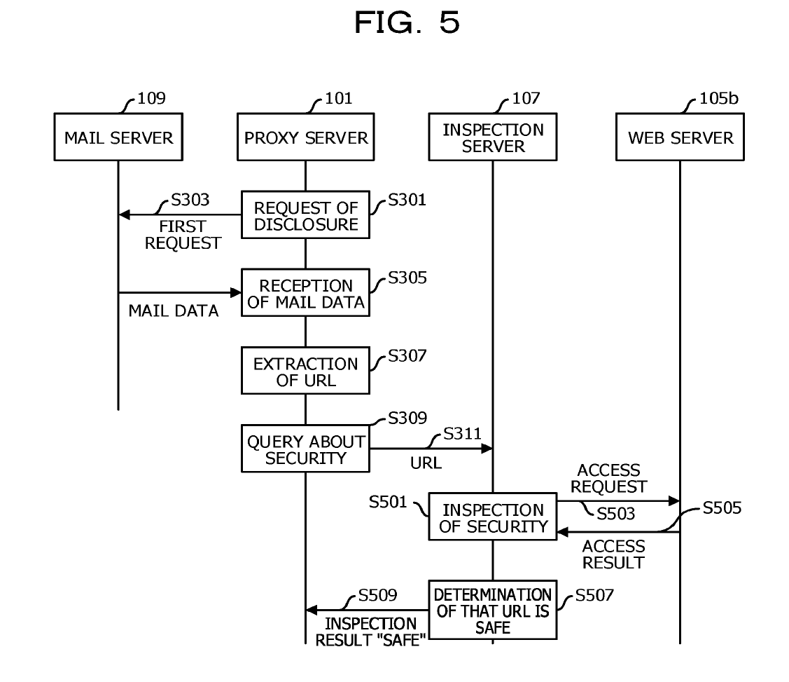

A checking phase and a relay phase when URL of the safe web server 105b (example of a safe URL) is inserted into a mail are described below. FIG. 5 illustrates a sequence example of a checking phase when a safe URL is inserted into a mail. Pieces of processing in S301 to S311 are similar to those of FIG. 3.

The inspection server 107 inspects security of URL (S501). The inspection server 107 transmits an access request, for example, to the web server 105b indicated by the URL (S503), and receives an access result from the web server 105b (S505).

When there is no possibility that the web server 105b dispatches malware, the inspection server 107 determines that an access to the resource indicated by the URL is safe. When the inspection server 107 determines the URL is safe (S507). The inspection server 107 transmits an inspection result indicating “safe” to the proxy server 101 (S509).

When the proxy server 101 receives the inspection result indicating “safe”, from the inspection server 107, the proxy server 101 does not record the URL that has been determined to be safe, to the blacklist.

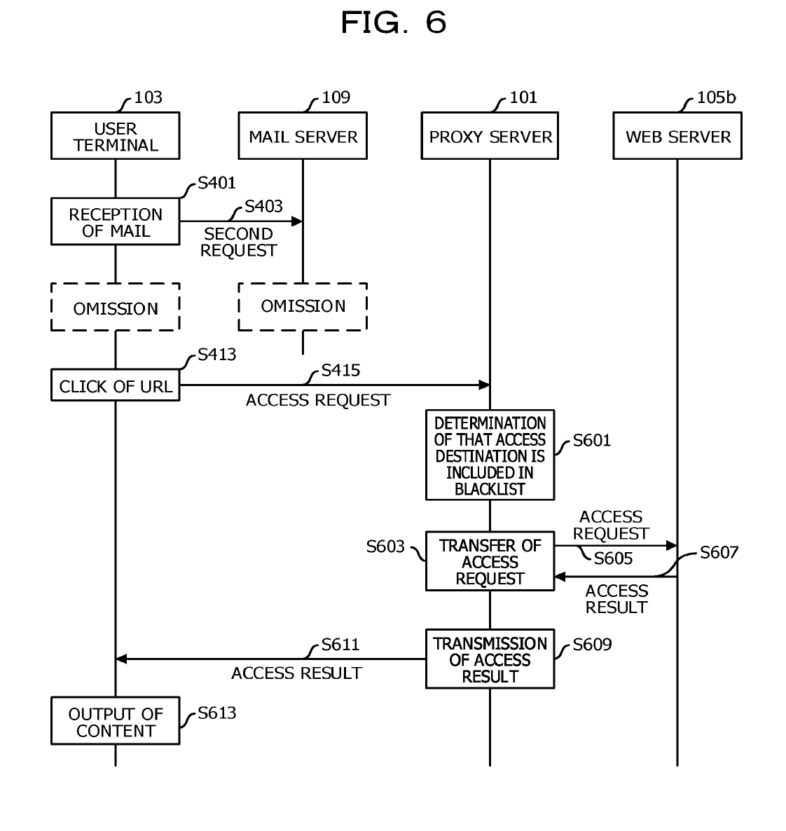

FIG. 6 illustrates a sequence example of a relay phase when transmission of an access request in which a safe URL is an access destination is performed. The sequence in S401 to S415 is similar to that of FIG. 4. In FIG. 6, the sequence in S405 to S411 is omitted.

When the proxy server 101 determines that the URL corresponding to the access destination is not included in the blacklist (S601), the proxy server 101 does not reject transfer of the access request. Thus, the proxy server 101 transfers the access request that has been received in S415, to the web server 105b (S603).

When the web server 105b receives the access request (S605), the web server 105b transmits an access result corresponding to a response for the access request (S607).

When the proxy server 101 receives the access result, the proxy server 101 transmits the received access result to the user terminal 103 (S609).

When the user terminal 103 receives the access result (S611), the user terminal 103 performs output of the content based on the access result (S613). The user terminal 103 displays, for example, a hypertext markup language (HTML) document. The description of the sequence is as described above.

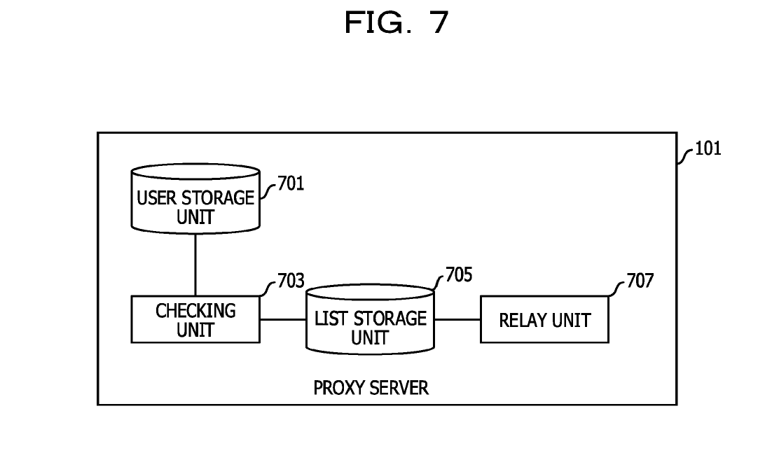

The detail of the proxy server 101 is described below. FIG. 7 illustrates a module configuration example of the proxy server 101. The proxy server 101 includes a user storage unit 701, a checking unit 703, a list storage unit 705, and a relay unit 707. The user storage unit 701 includes a list of users who use the user terminals 103 connected to the LAN, that is, users who perform transmission and reception of mails using the mail server 109 (hereinafter referred to as a user list). To the user list, data used to identify a user who uses the mail server 109 (for example, a mail address or a user ID) is set.

However, when pieces of mail data are processed collectively without distinguishing users who use the mail server 109, the user storage unit 701 may not be provided.

The checking unit 703 checks danger of an incoming mail disclosed by the mail server 109. The list storage unit 705 stores the blacklist to which pieces of malicious URL have been recorded. The relay unit 707 relays an access request transmitted from the user terminal 103 to the Internet, and relays an access result transmitted from the Internet to the user terminal 103. In addition, the relay unit 707 determines whether malicious URL is set as an access destination of a received access request, and rejects transfer of the access request in which malicious URL is set as the access destination.

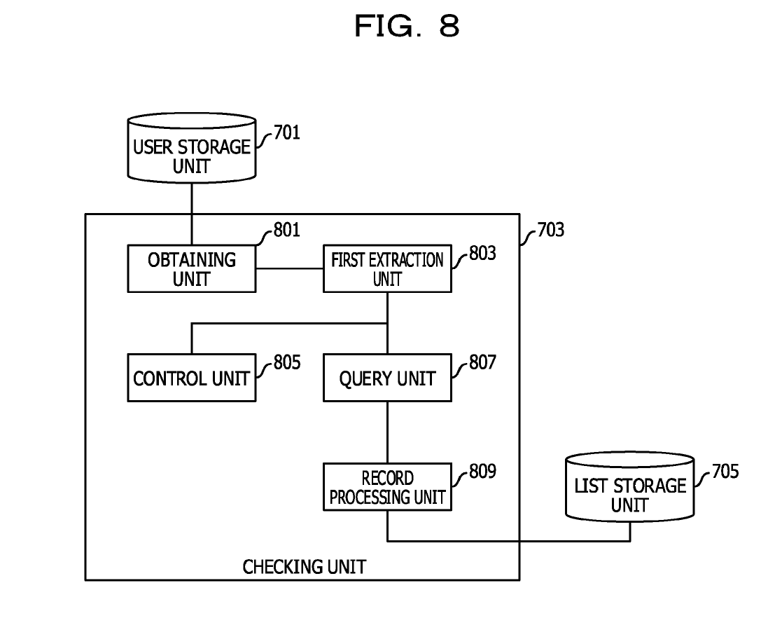

The detail of the checking unit 703 is described below. FIG. 8 illustrates a module configuration example of the checking unit 703. The checking unit 703 includes an obtaining unit 801, a first extraction unit 803, a control unit 805, a query unit 807, and a record processing unit 809. The obtaining unit 801 obtains mail data that has been disclosed by the mail server 109. The first extraction unit 803 extracts URL from the mail data. The control unit 805 controls checking processing by the checking unit 703. The query unit 807 queries about security of URL. The record processing unit 809 records malicious URL to the blacklist.

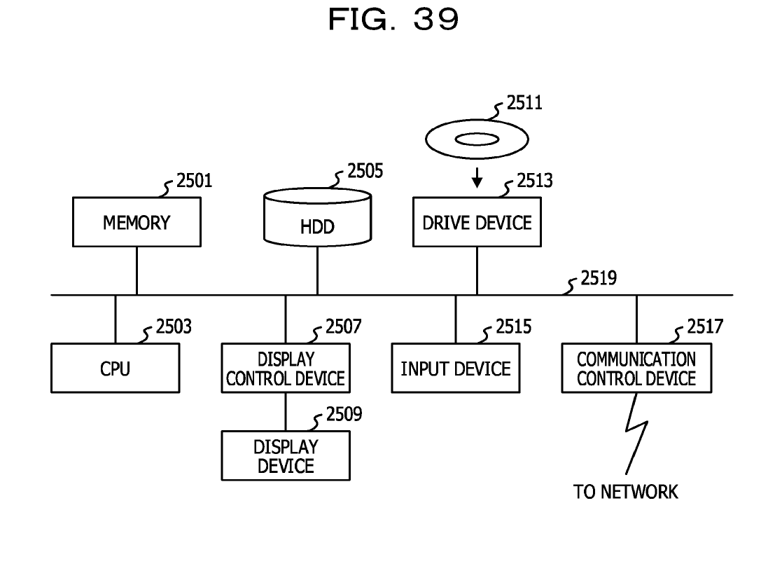

The checking unit 703, the relay unit 707, the obtaining unit 801, the first extraction unit 803, the control unit 805, the query unit 807, and the record processing unit 809 are achieved by using hardware resources (for example, FIG. 39) and a program that causes a processor to execute processing described below.

The user storage unit 701 and the list storage unit 705 are achieved by using the hardware resources (for example, FIG. 39).

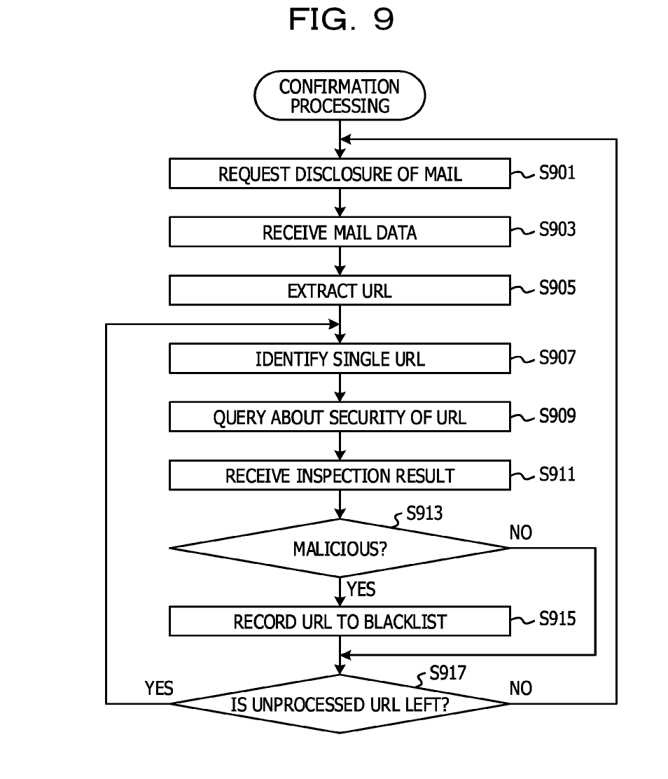

The checking processing by the checking unit 703 is described below. FIG. 9 illustrates an example of a checking processing flow. The obtaining unit 801 transmits a first request to the mail server 109 in order to request disclosure of mail data (S901). The first request includes data used to authenticate the proxy server 101 (for example, an equipment ID). The obtaining unit 801 may include data used to identify the user who is managed by the user list stored in the user storage unit 701 (for example, a mail address or a user ID), in the first request.

The obtaining unit 801 receives newly arrived mail data (S903). The received mail data corresponds to one or a plurality of mails. The first extraction unit 803 extracts URL from the received mail data (S905). For example, the first extraction unit 803 searches for a character string of a scheme name “http:” included in the body of the mail data, and extracts URL based on the data format of the URL. However, the first extraction unit 803 may search for a further scheme name. A single or a plurality of pieces of URL are extracted.

The control unit 805 identifies a single URL that is a processing target, from among the extracted pieces of URL (S907). The query unit 807 queries the inspection server 107 about security of the URL (S909). At this time, the URL that is the inspection target is transmitted from the proxy server 101 to the inspection server 107.

In addition, the query unit 807 receives an inspection result from the inspection server 107 (S911). The record processing unit 809 determines whether the received inspection result indicates “malicious” (S913). When the record processing unit 809 determines that the received inspection result indicates “malicious”, the record processing unit 809 records the URL that is the inspection target, to the blacklist (S915). In addition, the flow proceeds to the processing illustrated in S917.

In addition, when the record processing unit 809 determines that the received inspection result does not indicate “malicious”, that is, when the inspection result indicates “safe”, the inspection server 107 does not record the URL that is the inspection target to the blacklist. In addition, the flow proceeds to the processing illustrated in S917.

The control unit 805 determines whether there is an unprocessed URL from among the pieces of URL that have been extracted in S905 (S917). When the control unit 805 determines that there is an unprocessed URL, the flow returns to the processing of S907, and the above-described pieces of processing are repeated.

In addition, the control unit 805 determines that there is no unprocessed URL, the flow returns to the processing of S901, and the above-described pieces of processing are repeated.

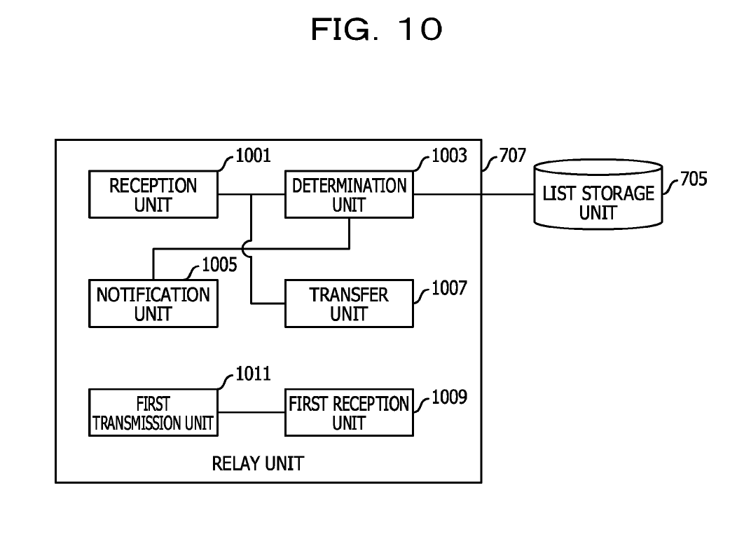

The detail of the relay unit 707 is described below. FIG. 10 illustrates a module configuration example of the relay unit 707. The relay unit 707 includes a reception unit 1001, a determination unit 1003, a notification unit 1005, a transfer unit 1007, a first reception unit 1009, and a first transmission unit 1011.

The reception unit 1001 receives an access request that is to be relayed, from the user terminal 103. The determination unit 1003 performs various pieces of determination. The notification unit 1005 notifies a device that is a source of the access request of rejection of the access request. The transfer unit 1007 transfers the access request to a device that is an access destination. The first reception unit 1009 receives an access result from the device that is the access destination. The first transmission unit 1011 transmits the access result to the device that is the source of the access request.

The reception unit 1001, the determination unit 1003, the notification unit 1005, the transfer unit 1007, the first reception unit 1009, and the first transmission unit 1011 are achieved by using the hardware resources (for example, FIG. 39) and the program that causes the processor to execute the processing described below.

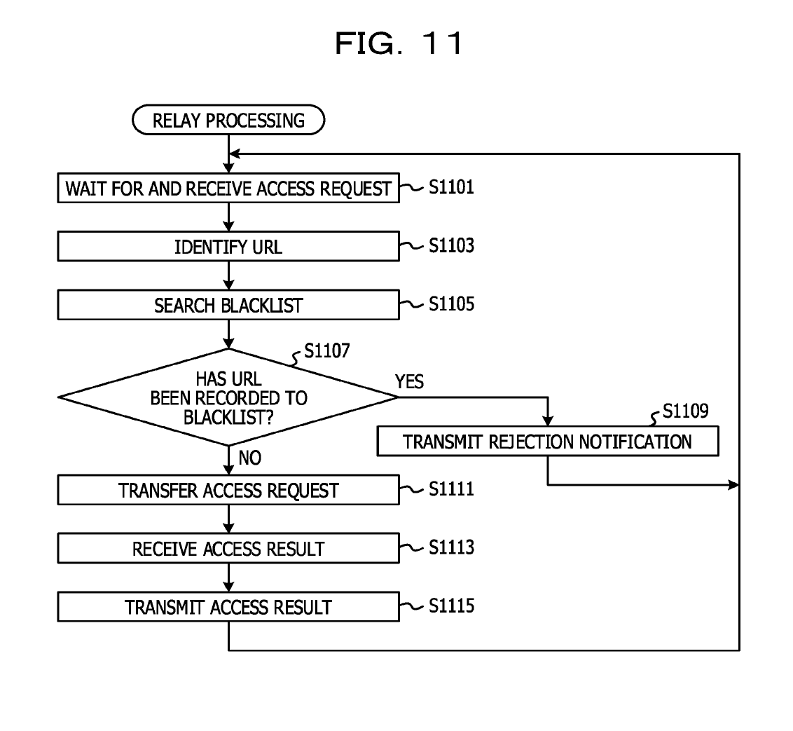

The reply processing by the relay unit 707 is described below. The relay processing is executed in parallel with the above-described checking processing. FIG. 11 illustrates an example of a relay processing flow by the relay unit 707. The reception unit 1001 waits for an access request that is to be relayed, and receives the access request from the user terminal 103 (S1101). The determination unit 1003 identifies URL corresponding to an access destination of the received access request (S1103). The determination unit 1003 searches the blacklist using the identified URL as a key (51105). In addition, the determination unit 1003 determines whether the identified URL is included in the blacklist (S1107). When the determination unit 1003 determines that the identified URL is included in the blacklist, the transfer unit 1007 does not transfer the access request. In addition, the notification unit 1005 transmits rejection notification to the user terminal 103 (S1109). In addition, the flow returns to the processing of S1101, and the above-described pieces of processing are repeated.

In addition, when the determination unit 1003 determines that the identified URL is not included in the blacklist, the transfer unit 1007 transfers the access request that has been received in S1101 (S1111). The first reception unit 1009 receives an access result from the web server 105 that is the access destination (S1113). The first transmission unit 1011 transmits the received access result to the user terminal 103 that is the source of the access request (51115). In addition, the flow returns to the processing of S1101, and the above-described pieces of processing are repeated. The description of the proxy server 101 is as described above.

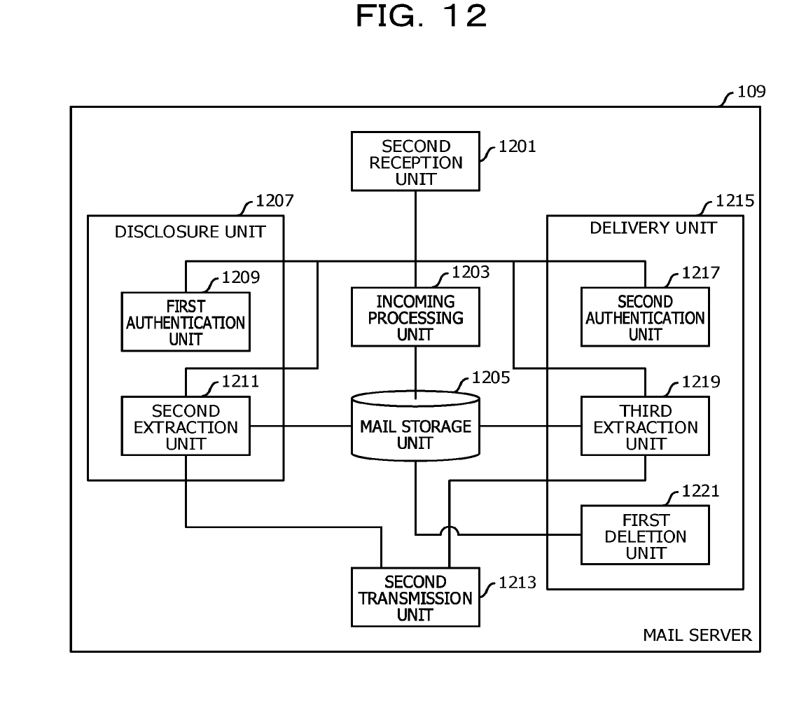

The detail of the mail server 109 is described below. FIG. 12 illustrates a module configuration example of the mail server 109. The mail server 109 includes a second reception unit 1201, an incoming processing unit 1203, a mail storage unit 1205, a disclosure unit 1207, a second transmission unit 1213, and a delivery unit 1215.

The second reception unit 1201 receives a first request from the proxy server 101, and receives a second request from the user terminal 103. The incoming processing unit 1203 writes incoming mail data to the mail storage unit 1205. The mail storage unit 1205 stores the mail data.

The disclosure unit 1207 executes processing for disclosing mail data to the proxy server 101. The disclosure unit 1207 includes a first authentication unit 1209 and a second extraction unit 1211. The first authentication unit 1209 authenticates the proxy server 101. The second extraction unit 1211 extracts mail data that is to be disclosed.

The second transmission unit 1213 transmits the mail data that is to be disclosed, to the proxy server 101, and transmits the mail data addressed to the user to the user terminal 103.

The delivery unit 1215 executes processing for delivering the mail data to the user terminal 103. The delivery unit 1215 includes a second authentication unit 1217, a third extraction unit 1219, and a first deletion unit 1221. The second authentication unit 1217 authenticates the user. The third extraction unit 1219 extracts the mail data addressed to the user. The first deletion unit 1221 deletes the mail data that has been transmitted to the user.

The second reception unit 1201, the incoming processing unit 1203, the disclosure unit 1207, the first authentication unit 1209, the second extraction unit 1211, the second transmission unit 1213, the delivery unit 1215, the second authentication unit 1217, the third extraction unit 1219, and the first deletion unit 1221 are achieved by the hardware resources (for example, FIG. 39) and the program that causes the processor to execute the processing described below.

In addition, the mail storage unit 1205 is achieved by using the hardware resources (for example, FIG. 39).

Processing of the mail server 109 is described below. Processing in which the incoming processing unit 1203 causes newly arrived mail data to be stored in the mail storage unit 1205 is similar to a technology in the related art, so that the description is omitted herein.

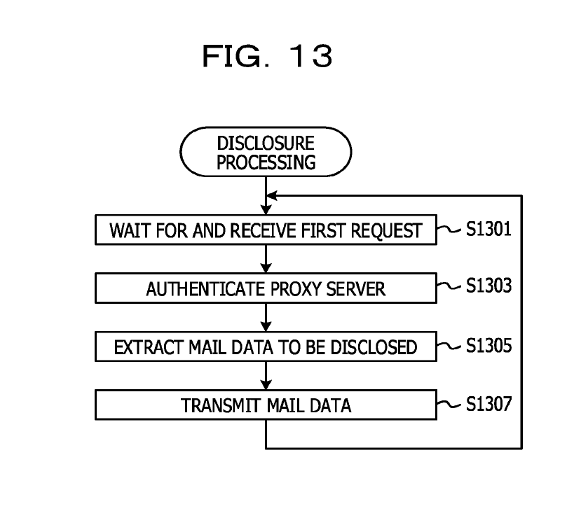

Disclosure processing of the disclosure unit 1207 is described below. FIG. 13 illustrates an example of a disclosure processing flow. The second reception unit 1201 waits for a first request and receives the first request from the proxy server 101 (S1301). The first authentication unit 1209 authenticates the proxy server 101, based on authentication data included in the received first request (for example, an equipment ID) (S1303). When the authentication has not been performed successfully, in the disclosure unit 1207, the flow returns to the processing of S1301 without execution of pieces of processing S1305 to S1307.

When the authentication has been performed successfully, the second extraction unit 1211 extracts mail data that is to be disclosed (S1305). For example, the second extraction unit 1211 extracts mail data that is yet to be disclosed to the proxy server 101. When the first request that has been received in S1301 includes data used to identify the user (for example, a mail address or a user ID), the second extraction unit 1211 may extract mail data addressed to the user.

The second transmission unit 1213 transmits the extracted mail data to the proxy server 101 (S1307).

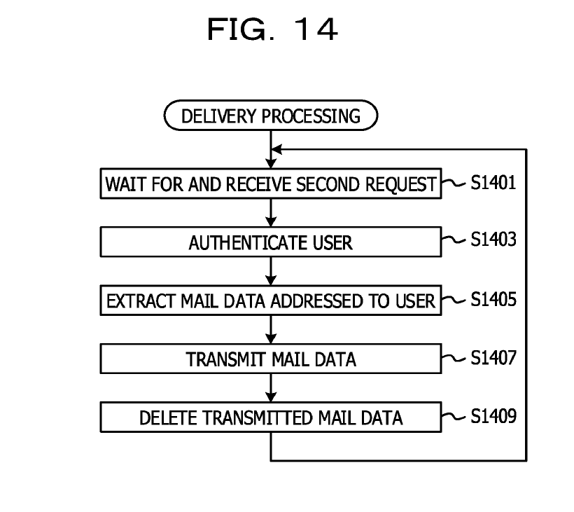

Processing of the delivery unit 1215 is described below. The processing of the delivery unit 1215 is executed in parallel with the above-described processing of the disclosure unit 1207. FIG. 14 illustrates an example of a delivery processing flow. The second reception unit 1201 waits for a second request and receives the second request from the user terminal 103 (S1401). The second authentication unit 1217 authenticates the user based on account data included in the second request (S1403). When the authentication has not been performed successfully, in the delivery unit 1215, the flow returns to the processing of S1401 without execution of pieces of processing of S1405 to S1409.

When the authentication has been performed successfully, the third extraction unit 1219 extracts mail data addressed to the authenticated user (S1405). For example, the third extraction unit 1219 extracts mail data that is yet to be transmitted to the user. The second transmission unit 1213 performs transmission of the extracted mail data (S1407). In addition, in such an example, the first deletion unit 1221 deletes the transmitted mail data (S1409). However, the delivery unit 1215 may not delete the transmitted mail data. In addition, timing at which the mail data is deleted is not limited to such an example.

In the embodiment, when the user accesses a link destination that has been inserted into an incoming mail, it may be automatically determined whether the link destination is a pernicious resource. When the proxy server 101 checks mails addressed to the users who use the LAN collectively, security of the entire LAN may be ensured.

In addition, an access to the pernicious resource may be avoided in advance.

### Second Embodiment

In the first embodiment, the example is described in which the proxy server 101 inspects URL using the inspection server 107, but in a second embodiment, an example is described in which the proxy server 101 doubles as the inspection server 107 without using the inspection server 107.

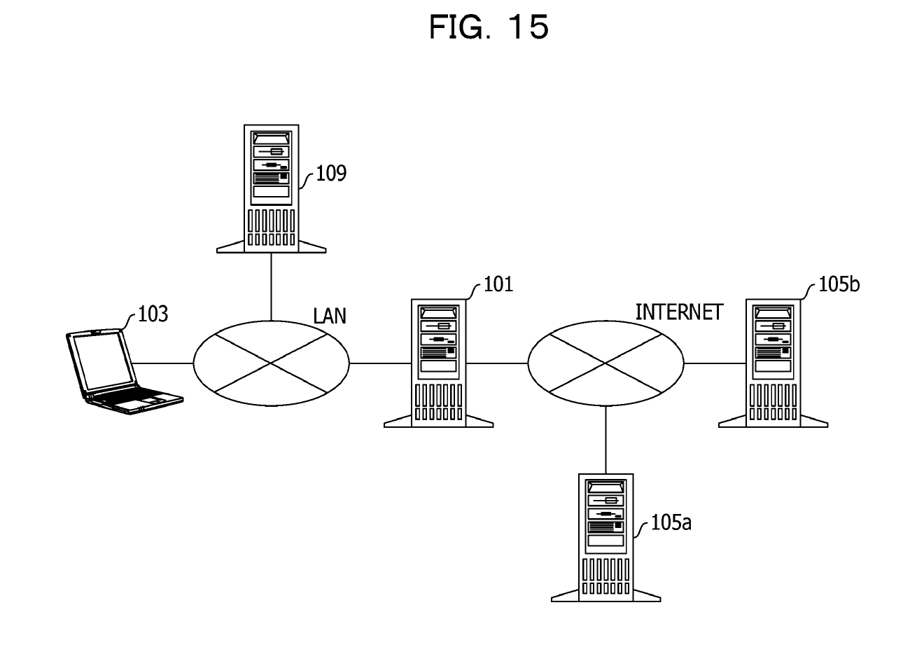

In the embodiment, a third example of a network configuration illustrated in FIG. 15 is assumed. In such an example, the proxy server 101 includes a function corresponding to the inspection server 107 illustrated in FIGS. 1 and 2. That is, the proxy server 101 includes an inspection unit that inspects danger of a resource indicated by URL. In addition, the proxy server 101 inspects danger of the resource indicated by the URL by itself.

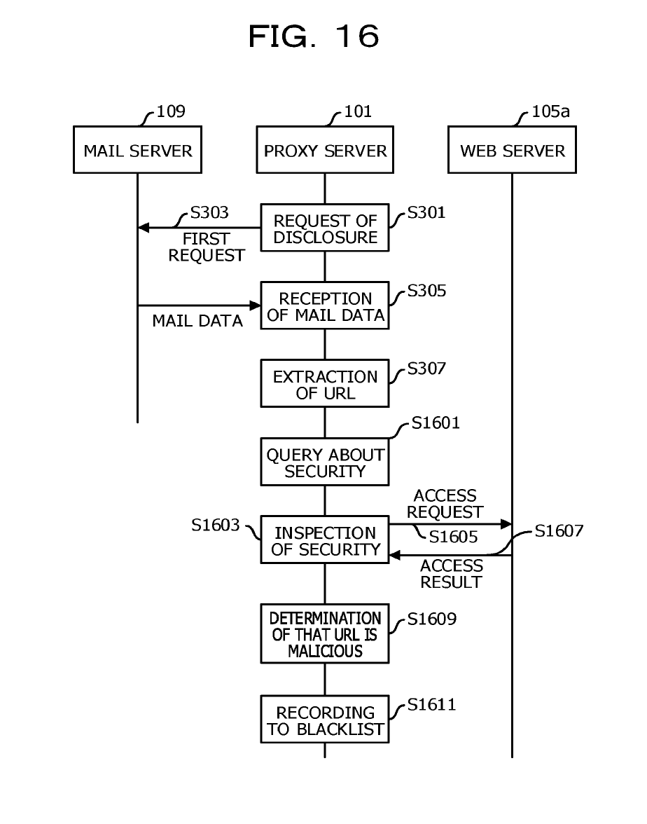

A sequence in the second embodiment is described below. FIG. 16 illustrates a sequence example of a checking phase when malicious URL is inserted into a mail. Pieces of processing in S301 to S307 are similar to those of FIG. 3.

The proxy server 101 queries the inspection unit included in the proxy server 101 about security of URL (S1601). The proxy server 101 inspects the security of the URL by itself (S1603). At this time, the proxy server 101 transmits an access request, for example, to the web server 105a indicated by the URL (S1605), and receives an access result from the web server 105a (S1607). The procedure of the inspection is similar to that of the inspection server 107.

When the proxy server 101 determines that the URL that is the inspection target is malicious (S1609), the proxy server 101 records the URL that has been determined to be malicious, to the blacklist (S1611).

A sequence in a reply phase when transmission of an access request in which malicious URL is an access destination is performed is similar to that of the first embodiment (FIG. 4).

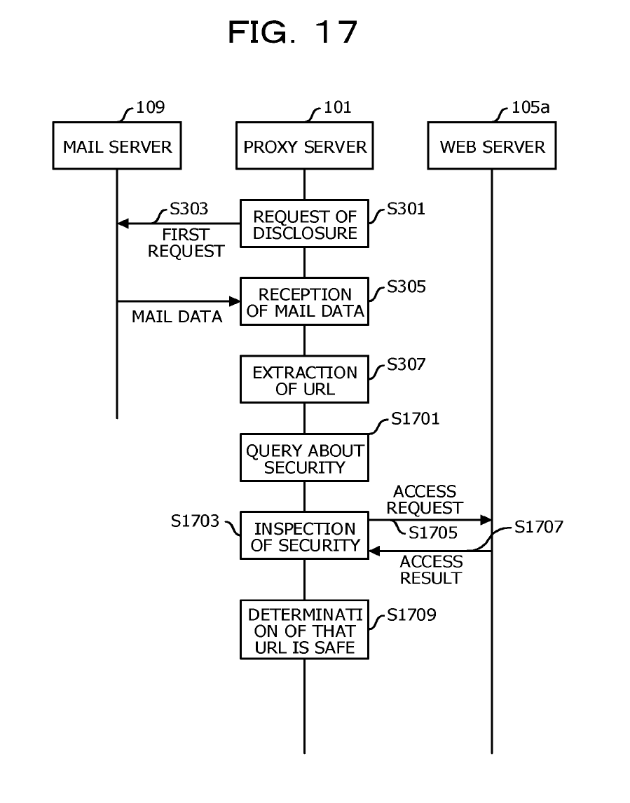

A sequence example in a checking phase when a safe URL is inserted into a mail is described below with reference to FIG. 17. Pieces of processing in S301 to S307 are similar to those of FIG. 3. The proxy server 101 queries the inspection unit included in the proxy server 101 about security of URL (S1701). The proxy server 101 inspects security of the URL by itself (S1703). At this time, the proxy server 101 transmits an access request, for example, to the web server 105b indicated by the URL (S1705), and receives an access result from the web server 105b (S1707).

When the proxy server 101 determines that the URL is safe (S1709), the proxy server 101 does not record the URL that has been determined to be safe, to the blacklist.

A sequence in a relay phase when transmission of an access request in which a safe URL is an access destination is performed is similar to that of the first embodiment (FIG. 6).

In addition, a module configuration of the proxy server 101 is similar to that of the first embodiment (FIG. 7). However, a configuration of a checking unit 703 according to the second embodiment is different from that of the first embodiment (FIG. 8).

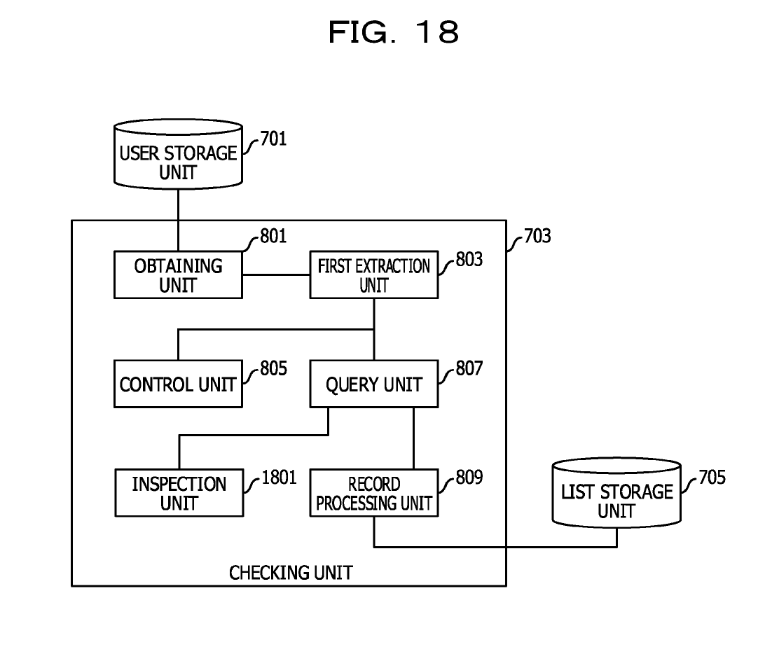

FIG. 18 illustrates a module configuration example of the checking unit 703 according to the second embodiment. The checking unit 703 according to the second embodiment includes an inspection unit 1801. The inspection unit 1801 inspects security of URL.

The inspection unit 1801 is achieved by the hardware resources (for example, FIG. 39) and the program that causes the processor to execute the processing described below.

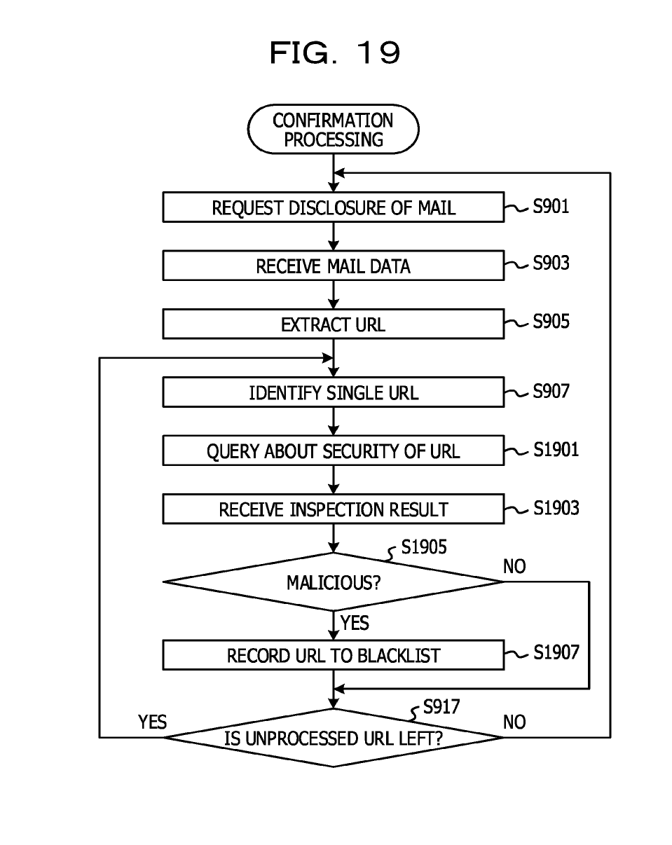

Confirmation processing of the checking unit 703 is described below. FIG. 19 illustrates an example of a checking processing flow in the second embodiment. The pieces of processing of S901 to S907 are similar to those of FIG. 9.

The query unit 807 queries the inspection unit 1801 about security of URL (S1901). At this time, the URL that is the inspection target is transmitted from the query unit 807 to the inspection unit 1801.

The inspection unit 1801 executes inspection processing (S1903). The inspection processing in the inspection unit 1801 is similar to that of the inspection server 107. For example, the inspection unit 1801 transmits an access request to the web server 105 indicated by the URL that is the inspection target, and receives an access result from the web server 105. The inspection unit 1801 determines whether there is a possibility that the web server 105 dispatches malware, based on a behavior of the web server 105 at this time. When there is a possibility that the web server 105 dispatches malware, the inspection unit 1801 determines that the access to the resource indicated by the URL is malicious. When there is no possibility that the web server 105 dispatches malware, the inspection unit 1801 determines that the access to the resource indicated by the URL is safe.

The record processing unit 809 determines whether the inspection result indicates “malicious” (S1905). When the record processing unit 809 determines that the inspection result indicates “malicious”, the record processing unit 809 records the URL that is the inspection target, to the blacklist (S1907). In addition, the flow proceeds to the processing illustrated in S917.

In addition, when the record processing unit 809 determines that the inspection result does not indicate “malicious”, that is, the inspection result indicates “safe”, the record processing unit 809 does not record the URL that is the inspection target to the blacklist. In addition, the flow proceeds to the processing illustrated in S917.

The processing of S917 is similar to that of FIG. 9.

A module configuration of the relay unit 707 is similar that of the first embodiment (FIG. 10).

Relay processing is also similar to that of the first embodiment (FIG. 11).

In addition, a module configuration of the mail server 109 is similar to that of the first embodiment (FIG. 12). Disclosure processing is also similar to that of the first embodiment (FIG. 13). In addition, Delivery processing is also similar to that of the first embodiment (FIG. 14).

In the embodiment, communication cost desired for inspecting a link destination may be reduced. In addition, specific inspection criteria may be provided.

### Third Embodiment

Some web servers 105 merely respond for a first access request from among access requests. As described above, URL used for an access that is valid merely once is referred to a one-time URL.

However, in the checking phase, when the inspection unit 1801 of the proxy server 101 accesses the web server 105 using a one-time URL, the one-time URL becomes invalid after that. That is, in the relay phase, it is difficult for the user to access to the web server 105 or obtain an expected access result when the user tries to access the web server 105 using the one-time URL. For example, in a case of service that provides a password merely for a first access, the password is not provided for a second access.

In a third embodiment, such a failure is solved. That is, when a one-time URL is included in mail data, the user can obtain an access result even after inspection of the one-time URL.

Therefore, the proxy server 101 stores the access result that has been obtained by an initial access in the checking phase, in the cache storage unit provided in the proxy server 101. In addition, the access result accumulated in the cache storage unit is sent back merely for an initial access request from the user terminal 103. As a result, when the user accesses a one-time URL through the user terminal 103 for the first time, an access result is obtained normally.

However, after the access result has been set back to the user terminal 103, the access result accumulated in the cache storage unit is deleted. Thus, even when the same access request is transmitted from the user terminal 103 again, the initial access result is not obtained.

In the embodiment, the third example of the network configuration illustrated in FIG. 15 is assumed. The proxy server 101 includes the cache storage unit as described above. The detail of the cache storage unit is described later.

A sequence in the third embodiment is described below. A sequence in a checking phase when malicious URL is inserted into a mail is similar to that of the second embodiment (FIG. 16).

In addition, a sequence in a relay phase when transmission of an access request in which malicious URL is an access destination is performed is similar to that of the first embodiment (FIG. 4).

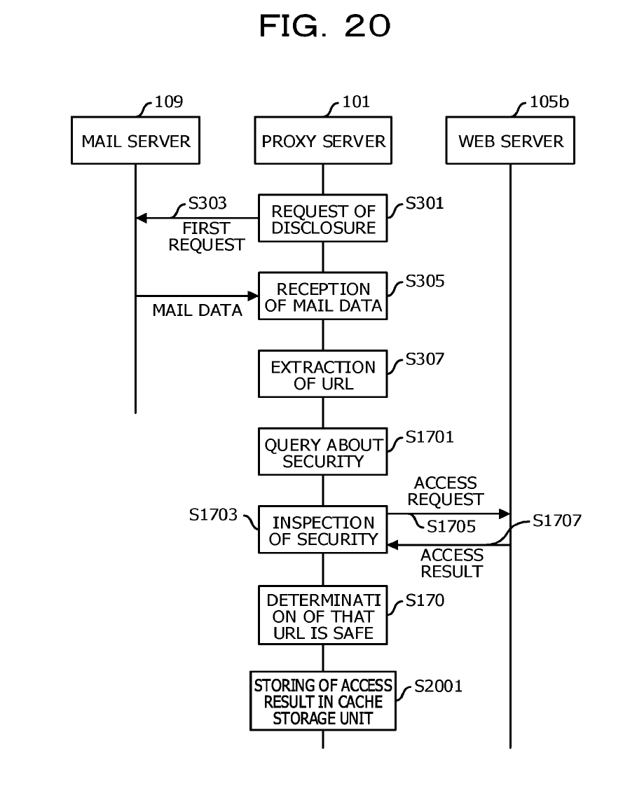

FIG. 20 illustrates a sequence example of a checking phase when a safe URL is inserted into a mail. Pieces of processing in S301 to S307 are similar to those of FIG. 3. In addition, pieces of processing in S1701 to S1709 are similar to those of FIG. 17.

In the inspection of security for the URL illustrated in S1703, when the proxy server 101 determines that the URL that is the inspection target is safe (S1709), the proxy server 101 stores the access result that has been received in S1707 in the cache storage unit so as to associate the access result with the URL that has been determined to be safe (S2001).

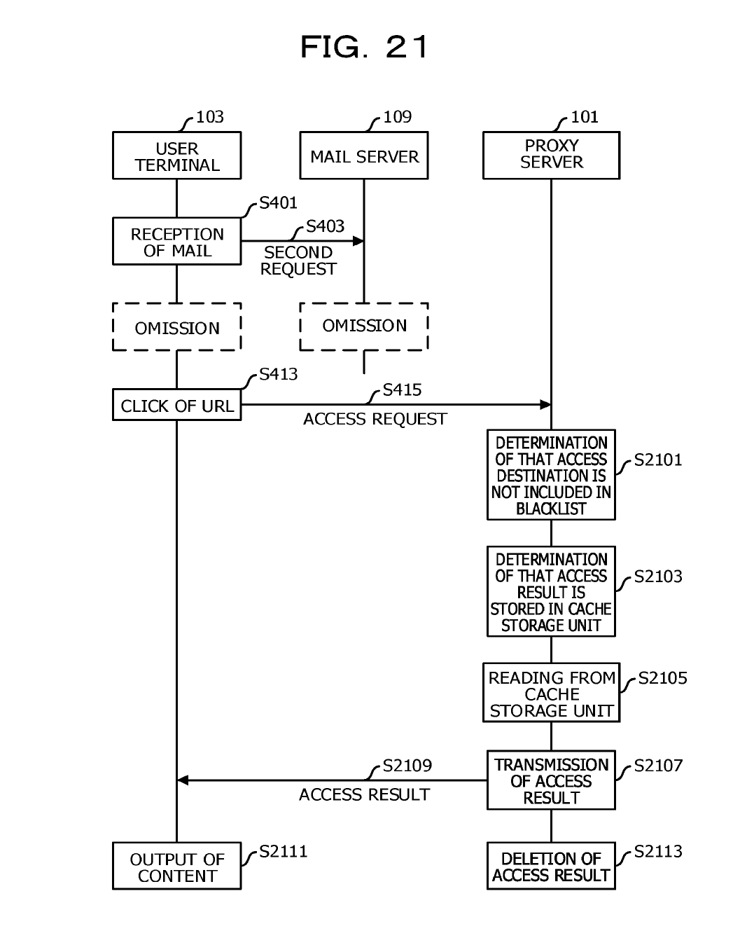

A sequence example in a relay phase when transmission of an access request in which a safe URL is an access destination is performed for the first time is described below with reference to FIG. 21. A sequence in S401 to S415 is similar to that of FIG. 4. In FIG. 21, the sequence in S405 to S411 is omitted.

When the proxy server 101 determines that the URL corresponding to the access destination is not included in the blacklist (S2101), the proxy server 101 does not reject the access request. However, in the embodiment, instead of transfer of the access request, an access result stored in the cache storage unit is used.

In such an example, since an initial access request has been transmitted, the access result has been stored in the cache storage unit. When the access result has been stored in the cache storage unit (S2103), the proxy server 101 reads the access result from the cache storage unit (S2105). In addition, the proxy server 101 transmits the read access result to the user terminal 103 (S2107). The above-described initial access request corresponds to a new access request for the proxy server 101.

When the user terminal 103 receives the access result (S2109), the user terminal 103 performs output of the content based on the access result (S2111). The user terminal 103 displays, for example, an HTML document.

After the proxy server 101 has transmitted the access result to the user terminal 103, the proxy server 101 deletes the access result from the cache storage unit (S2113).

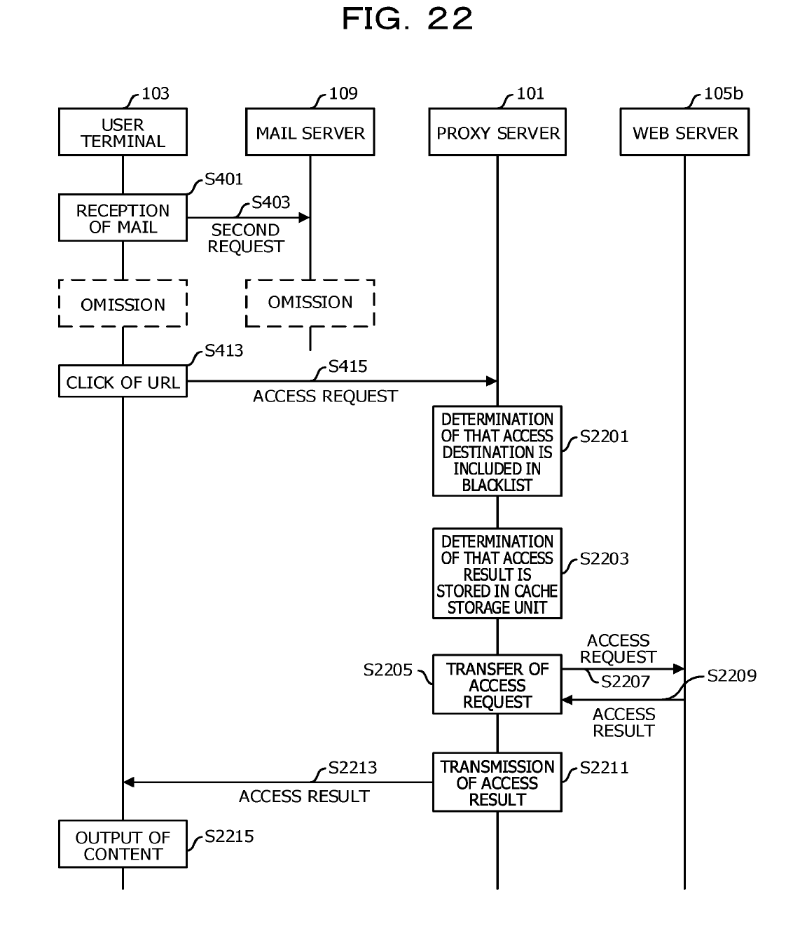

A sequence example in a relay phase when transmission of an access request in which a safe URL is an access destination is performed again is described below with reference to FIG. 22. A sequence in S401 to S415 is similar to that of FIG. 4. In FIG. 22, the sequence of S405 to S411 is omitted.

When the proxy server 101 determines that the URL corresponding to the access destination is not included in the blacklist (S2201), the proxy server 101 determines whether the access result is stored in the cache storage unit. In such an example, it is assumed that transmission of the access result for the initial access request has been already performed, and the access result is stored in the cache storage unit. When the proxy server 101 determines that the access result is not stored in the cache storage unit (S2203), the proxy server 101 transfers the access request that has been received in S415, to the web server 105b (S2205).

When the web server 105b receives an access request (S2207), the web server 105b performs transmission of an access result corresponding to a response for the access request (S2209).

When the proxy server 101 receives the access result, the proxy server 101 transmits the received access result to the user terminal 103 (S2211).

When the user terminal 103 receives the access result (S2213), the user terminal 103 performs output of the content, based on the access result (S2215). The user terminal 103 displays, for example, an HTML document. The sequence in the embodiment is as described above.

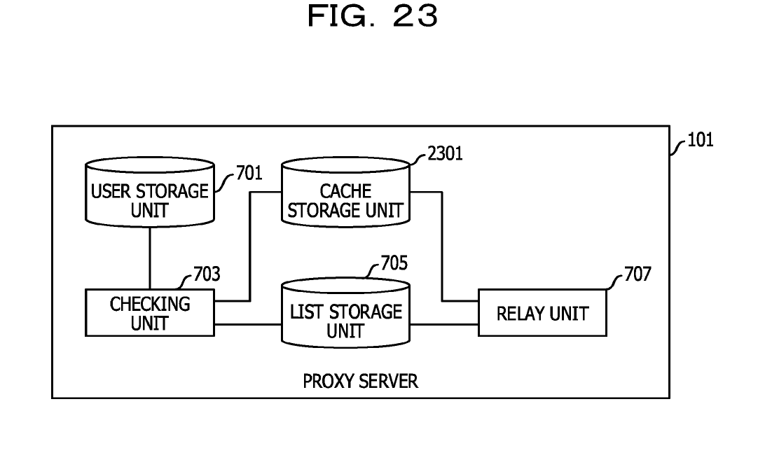

FIG. 23 illustrates a module configuration example of the proxy server 101 according to the third embodiment. The proxy server 101 according to the embodiment includes a cache storage unit 2301 as described above. The cache storage unit 2301 stores an access result as cache data. The cache storage unit 2301 is achieved by using the hardware resources (for example, FIG. 39).

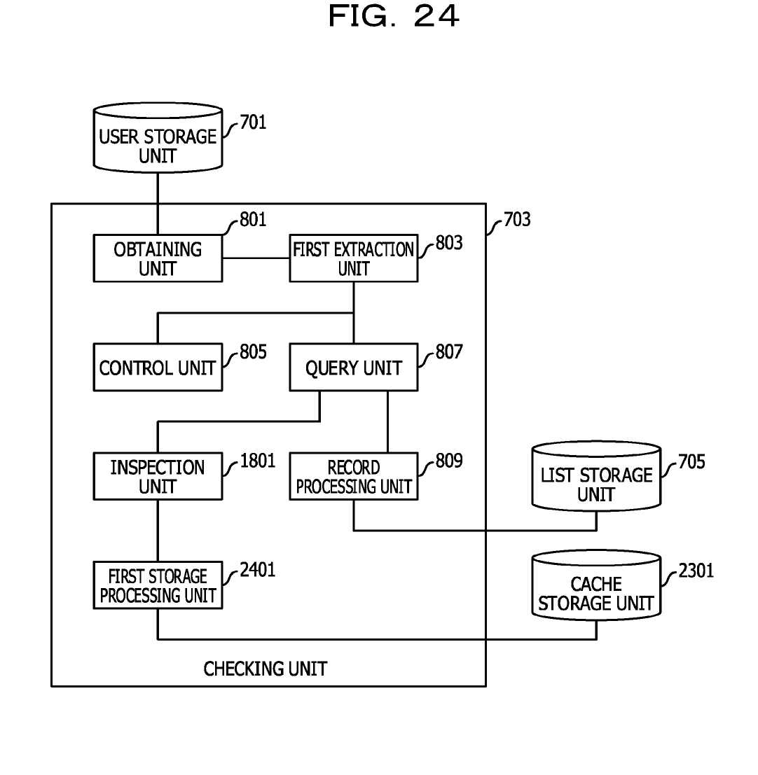

A checking unit 703 according to the third embodiment is described below. FIG. 24 illustrates a module configuration example of the checking unit 703 according to the third embodiment. The checking unit 703 according to the embodiment includes a first storage processing unit 2401. When an inspection result of URL indicates “safe”, the first storage processing unit 2401 stores the access result in the cache storage unit 2301 so as to associate the access result with the URL. The first storage processing unit 2401 is achieved by the hardware resources (for example, FIG. 39) and the program that causes the processor to execute the processing described below.

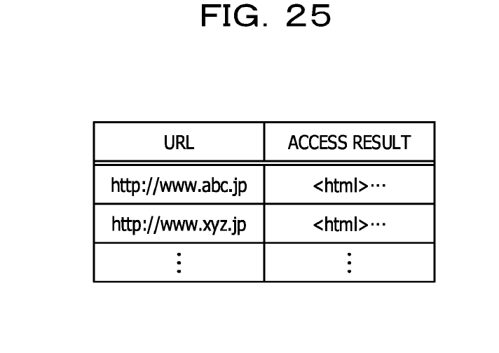

FIG. 25 illustrates an example of cache data. The cache data includes a safe URL and an access result associated with the URL.

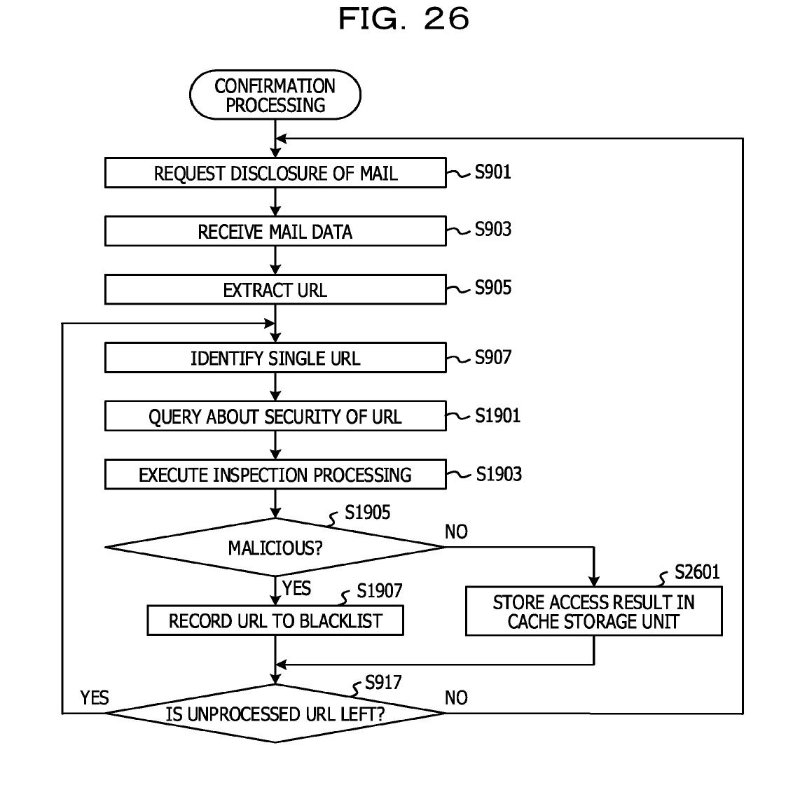

FIG. 26 illustrates an example of a checking processing flow in the third embodiment. Pieces of processing in S901 to S907 are similar to those of FIG. 9. In addition, pieces of processing in S1901 to S1907 are similar to those of FIG. 19.

When the record processing unit 809 determines that the inspection result does not indicate “malicious”, that is, the inspection result indicates “safe” in S1905, the first storage processing unit 2401 stores the access result that has been obtained in the inspection processing in S1903, in the cache storage unit 2301 so as to associate the access result with the URL that has been determined to be safe (S2601). In addition, the flow proceeds to the processing illustrated in S917.

Processing in S917 is similar to that of FIG. 9.

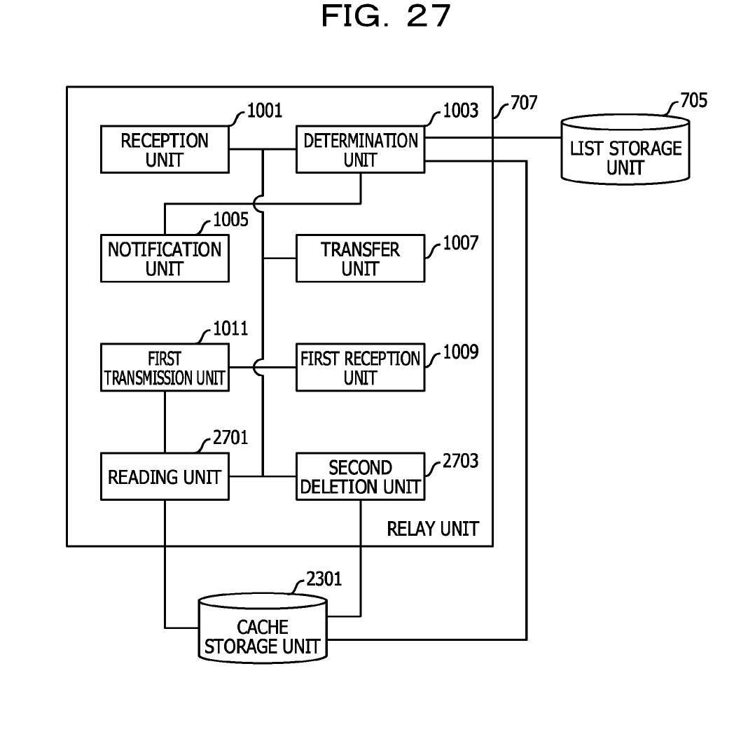

A relay unit 707 according to the third embodiment is described below. FIG. 27 illustrates a module configuration example of the relay unit 707 according to the third embodiment. The relay unit 707 according to the embodiment includes a reading unit 2701 and a second deletion unit 2703. The reading unit 2701 reads the access result from the cache storage unit 2301. The second deletion unit 2703 deletes the access result from the cache storage unit 2301. The reading unit 2701 and the second deletion unit 2703 are achieved by using the hardware resources (for example, FIG. 39) and the program that causes the processor to execute the processing described below.

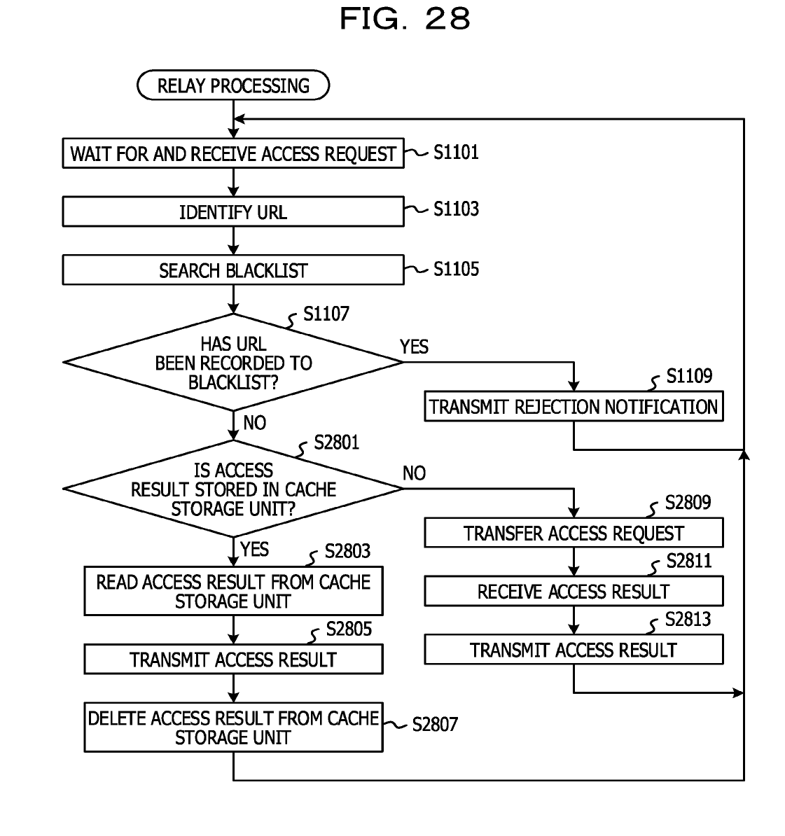

FIG. 28 illustrates an example of a relay processing flow in the third embodiment. Pieces of processing in S1101 to S1109 are similar those of FIG. 11.

In S1107, when the determination unit 1003 determines that the URL that has been identified in S1103 is not included in the blacklist, the determination unit 1003 determines whether the access result corresponding to the URL that has been identified in S1103 is stored in the cache storage unit 2301 (S2801). For example, when the URL that has been identified in S1103 is stored in the cache storage unit 2301, the determination unit 1003 determines that the access result is stored in the cache storage unit 2301.

When the determination unit 1003 determines that the access result corresponding to the URL that has been identified in S1103 is stored in the cache storage unit 2301, the reading unit 2701 reads the access result from the cache storage unit 2301 (S2803). The first transmission unit 1011 transmits the read access result to the user terminal 103 that is the source of the access request (S2805). The second deletion unit 2703 deletes the access result that has been read in S2803, from the cache storage unit 2301 (S2807). In addition, the flow returns to the processing of S1101, and the above-described pieces of processing are repeated.

In addition, when the determination unit 1003 determines that the access result corresponding to the URL that has been identified in S1103 is not stored in the cache storage unit 2301, the transfer unit 1007 transfers the access request that has been received in S1101 (S2809). The first reception unit 1009 receives the access result from the web server 105 that is the access destination (S2811). The first transmission unit 1011 transmits the received access result to the user terminal 103 that is the source of the access request (S2813). In addition, the flow returns to the processing of S1101, and the above-described pieces of processing are repeated.

A module configuration of the mail server 109 is similar to that of the first embodiment (FIG. 12). Disclosure processing is also similar to that of the first embodiment (FIG. 13). In addition, delivery processing is similar to that of the first embodiment (FIG. 14).

In the third embodiment, a first access result that has been obtained at the time of inspection of a link destination may be sent back to the user terminal 103. For example, a failure of an access to a one-time URL is avoided.

In addition, reuse of the first access result is avoided. For example, the purpose of a one-time URL is protected.

In addition, in a second or subsequent access, an appropriate access result may be obtained.

### Fourth Embodiment

In the above-described embodiment, the example is described in which whether an access request by the user terminal 103 is an initial request is distinguished by the presence or absence of cache data, but in a fourth embodiment, an example is described in which whether an access request by the user terminal 103 is the initial request is distinguished by a cached access result and a flag associated with URL.

In such an example, when “OFF” is set to the flag, the flag indicates that an access result is yet to be transmitted to the user terminal 103. In addition, when “ON” is set to the flag, the flag indicates that the access result has been already transmitted to the user terminal 103.

In the embodiment, the third example of the network configuration illustrated in FIG. 15 is assumed. For example, a proxy server 101 according to the embodiment may be achieved by modifying the proxy server 101 that accumulates the access results as cache data in the related art.

A sequence in the embodiment is described below. A sequence in the checking phase when malicious URL inserted into a mail is similar to that of the second embodiment (FIG. 16).

In addition, a sequence in a relay phase when transmission of an access request in which malicious URL is an access destination is performed is similar to that of the first embodiment (FIG. 4).

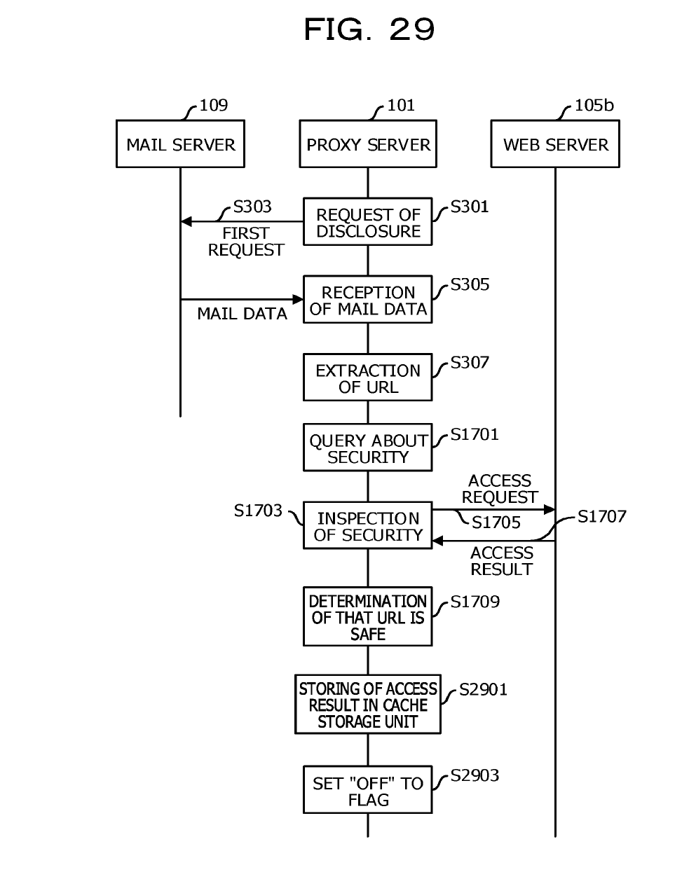

FIG. 29 illustrates a sequence in a checking phase example when a safe URL is inserted into a mail. Pieces of processing in S301 to S307 are similar to those of FIG. 3. The pieces of processing of S1701 to S1709 are similar to those of FIG. 17.

When the proxy server 101 determines that the URL is safe (S1709), the proxy server 101 stores the access result that has been received in S1707, in the cache storage unit 2301 so as to associate the access result with the URL that has been determined to be safe (S2901). In addition, the proxy server 101 sets “OFF” to the flag corresponding to the stored access result (S2903).

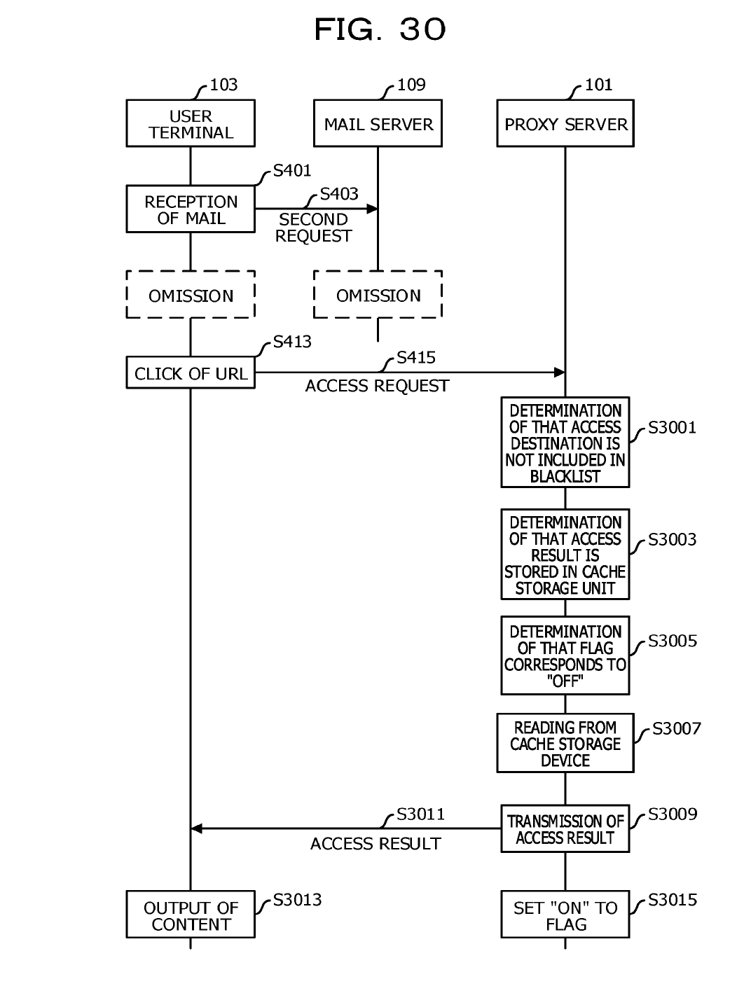

A sequence example in a relay phase when transmission of an access request in which a safe URL is an access destination is performed for the first time is described below with reference to FIG. 30. A sequence in S401 to S415 is similar to that of FIG. 4. In FIG. 30, the sequence of S405 to S411 is omitted.

When the proxy server 101 determines that the URL corresponding to the access destination is not included in the blacklist (S3001), the proxy server 101 determines whether the access result is stored in the cache storage unit 2301. When the proxy server 101 determines that the access result is stored in the cache storage unit 2301 (S3003), the proxy server 101 further determines whether the flag corresponding to the URL of the access destination corresponds to “ON” or “OFF”.

When an initial access request from the user terminal 103 is processed, an access result is yet to be transmitted to the user terminal 103. Thus, “OFF” is set to the flag corresponding to the URL of the access destination. When the proxy server 101 determines that the flag corresponding to the URL of the access destination corresponds to “OFF” (S3005), the proxy server 101 reads the access result from the cache storage unit 2301 (S3007), and transmits the read access result to the user terminal 103 (S3009).

When the user terminal 103 receives the access result (S3011), the user terminal 103 performs output of the content, based on the access result (S3013). For example, the user terminal 103 displays an HTML document.

After the proxy server 101 has transmitted the access result to the user terminal 103, the proxy server 101 sets “ON” to the flag corresponding to the URL of the access destination, which is included in the access request that has been received in S415 (S3015).

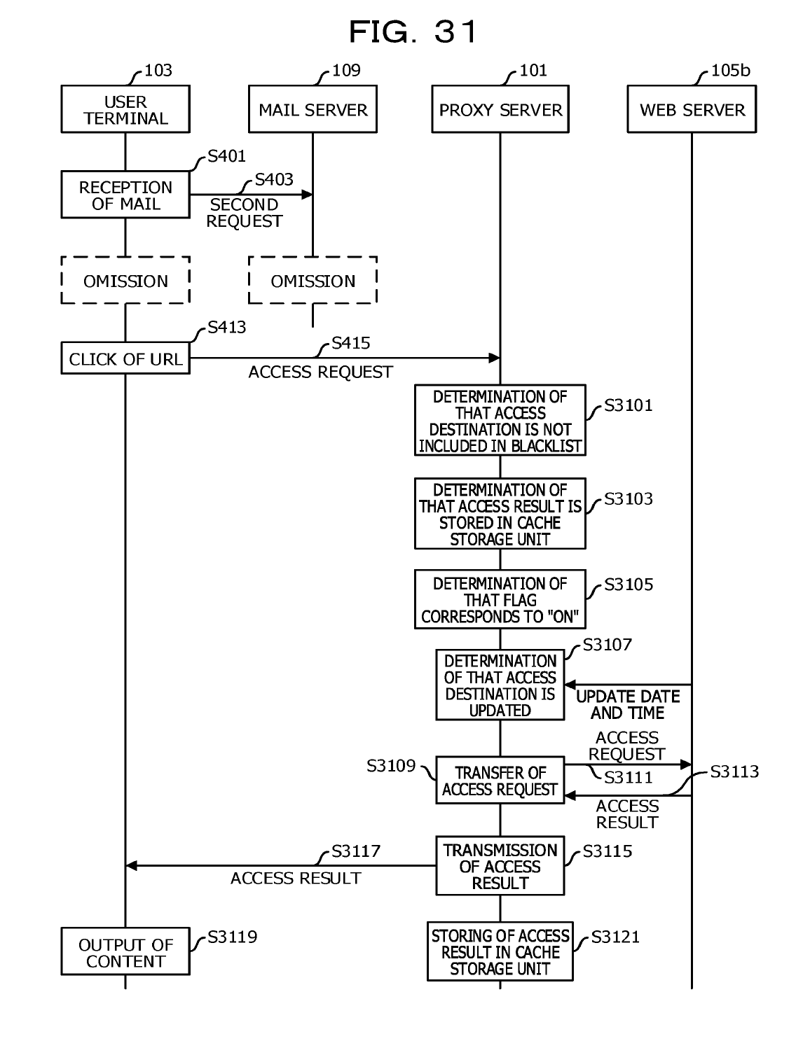

A sequence example in a relay phase when transmission of an access request in which a safe URL is an access destination is performed again is described below with reference to FIG. 31. In such an example, it is assumed that the resource of the web server 105b that is the access destination has been updated after the previous access. Hereinafter, update of the resource of the web server 105b is referred to as update of the web server 105b. A sequence in S401 to S415 is similar to that of FIG. 4. In FIG. 31, the sequence in S405 to S411 is omitted.

Similar to the cases in S3001 and S3003 illustrated in FIG. 30, when the proxy server 101 determines that the URL corresponding to the access destination is not included in the blacklist (S3101), and further determines that the access result is stored in the cache storage unit 2301 (S3103), the proxy server 101 further determines whether the flag corresponding to the URL of the access destination corresponds to “ON” or “OFF”.

For example, when a second access request from the user terminal 103 is processed, an access result is already transmitted to the user terminal 103. Thus, “ON” is set to the flag corresponding to the URL of the access destination. When the proxy server 101 determines that the flag corresponding to the URL of the access destination corresponds to “ON” (S3105), the proxy server 101 executes normal cache processing.

For example, the proxy server 101 inquires of the web server 105b the update date and time, and determines whether the web server 105b that is the access destination has been updated. The proxy server 101 determines that the web server 105b that is the access destination has been updated when the update date and time in the web server 105b that is the access destination is newer than the previous access date and time.

When the proxy server 101 determines that the web server 105b that is the access destination has been updated (S3107), the proxy server 101 transfers the access request that has been received in S415, to the web server 105b (S3109).

When the web server 105b receives the access request (S3111), the web server 105b performs transmission of an access result corresponding to a response for the access request (S3113).

When the proxy server 101 receives the access result, the proxy server 101 transmits the received access result to the user terminal 103 (S3115).

When the user terminal 103 receives the access result (S3117), the user terminal 103 performs output of the content, based on the access result (S3119). The user terminal 103 displays, for example, an HTML document.

After the proxy server 101 has transmitted the access result to the user terminal 103, the proxy server 101 stores the access result that has been received in S3113, in the cache storage unit 2301 so as to associate the access result with the URL corresponding to the access destination, which is included in the access request that has been received in S415 (S3121). That is, the proxy server 101 updates the access result.

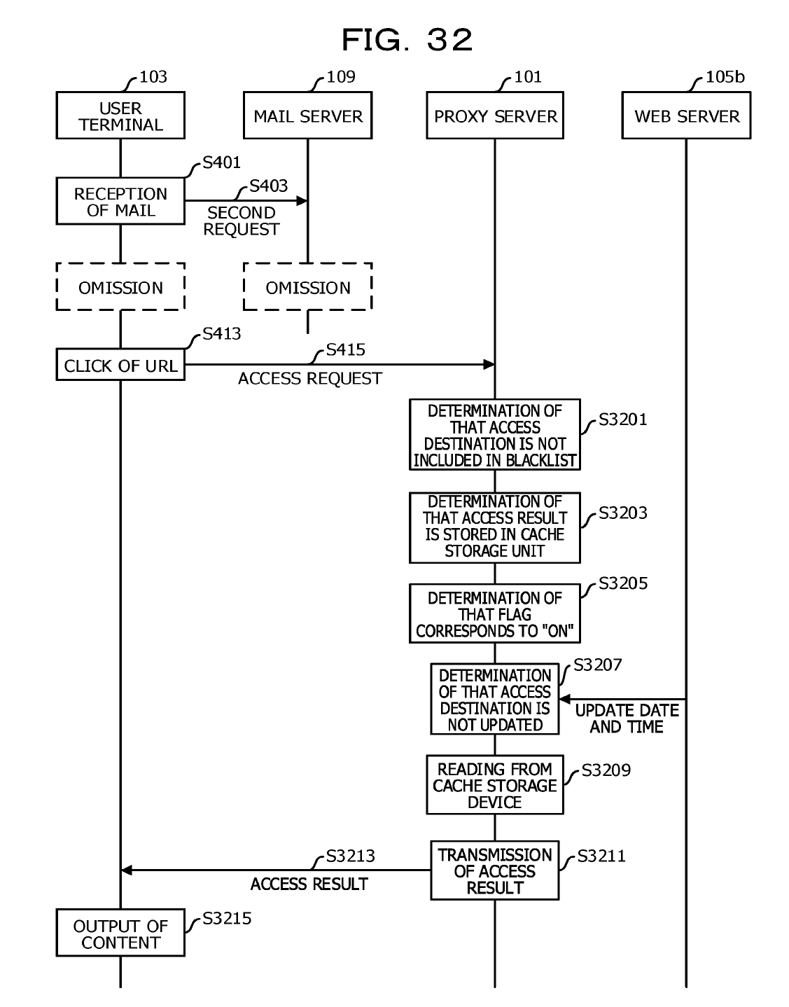

FIG. 32 illustrates a further sequence example in a relay phase when transmission of an access request in which a safe URL is an access destination is performed again. In such an example, it is assumed that the resource of the web server 105b that is the access destination is not updated after the previous access. Hereinafter, the non-update of the resource of the web server 105b is referred to as non-update of the web server 105b. A sequence in S401 to S415 is similar to that of FIG. 4. In FIG. 32, the sequence in S405 to S411 is omitted.

In addition, a sequence in S3201 to S3205 is similar to that of S3101 to S3105 illustrated in FIG. 31.

For example, when access is performed continuously, the web server 105b that is the access destination is often failed to be updated. When the proxy server 101 determines that the web server 105b that is the access destination is not updated (S3207), that is, that the update date and time in the web server 105b that is the access destination is older than the previous access date and time, the proxy server 101 reads an access result from the cache storage unit 2301 (S3209). In addition, the proxy server 101 transmits the read access result to the user terminal 103 (S3211).

When the user terminal 103 receives the access result (S3213), the user terminal 103 performs output of the content, based on the access result (S3215). The user terminal 103 displays, for example, an HTML document. The sequence in the embodiment is as described above.

A module configuration of the proxy server 101 is similar to that of the third embodiment (FIG. 23). However, configurations of a checking unit 703 and a relay unit 707 according to the fourth embodiment are different from those of the above-described embodiment.

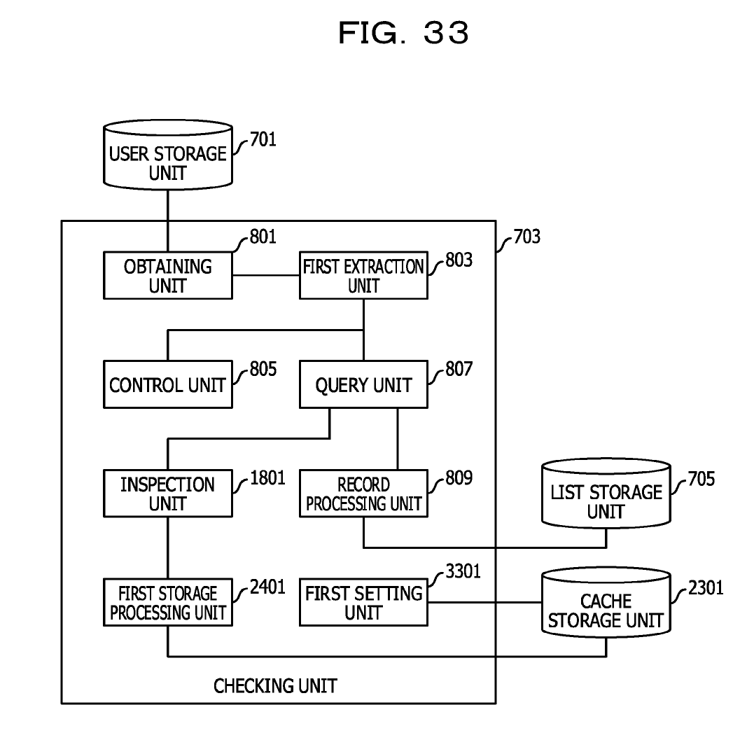

The checking unit 703 according to the fourth embodiment is described below. FIG. 33 illustrates a module configuration example of the checking unit 703 according to the fourth embodiment. The checking unit 703 according to the embodiment includes a first setting unit 3301. The first setting unit 3301 performs setting for a flag corresponding to URL and an access result. The first setting unit 3301 is achieved by the hardware resources (for example, FIG. 39) and the program that causes the processor to execute the processing described below.

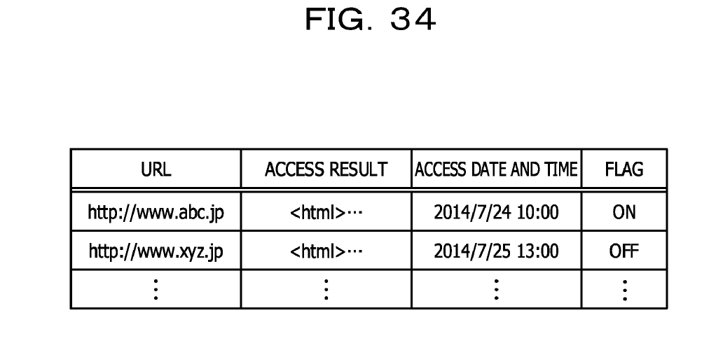

In addition, in the fourth embodiment, a configuration of cache data is also different from that of the above-described embodiment. FIG. 34 illustrates an example of cache data in the fourth embodiment. In addition to a safe URL and an access result associated with the URL, the cache data in the fourth embodiment includes a flag and an access date and time associated with the URL and the access result. The access date and time is updated each time an access to the URL is performed. That is, the access date and time indicates an access date and time in which the previous access has been performed. Hereinafter, processing for updating the access date and time is omitted.

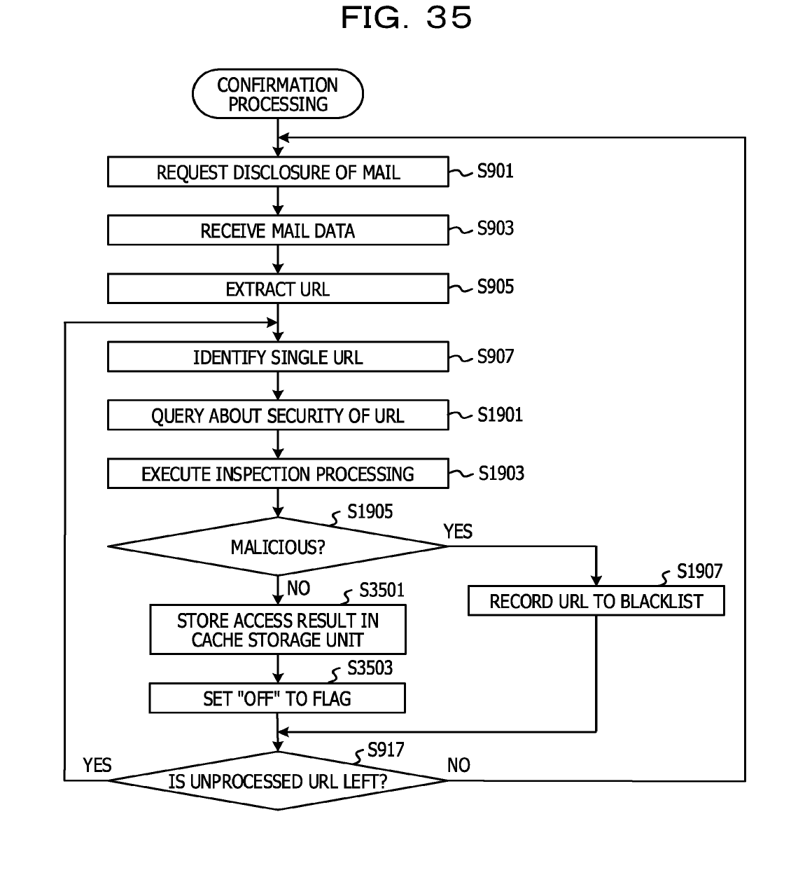

FIG. 35 illustrates an example of a checking processing flow in the fourth embodiment. Pieces of processing in S901 to S907 are similar to those of FIG. 9. Pieces of processing in S1901 to S1907 are similar to those of FIG. 19.

When the record processing unit 809 determines that the inspection result does not indicate “malicious”, that is, the inspection result indicates “safe”, in S1905, the first storage processing unit 2401 stores the access result that has been obtained in the inspection processing of S1903, in the cache storage unit 2301 so as to associate the access result with the URL that has been determined to be safe (S3501). In addition, the first setting unit 3301 sets “OFF” to the flag corresponding to the stored access result (S3503). In addition, the flow proceeds to the processing illustrated in S917.

Processing in S917 is similar to that of FIG. 9.

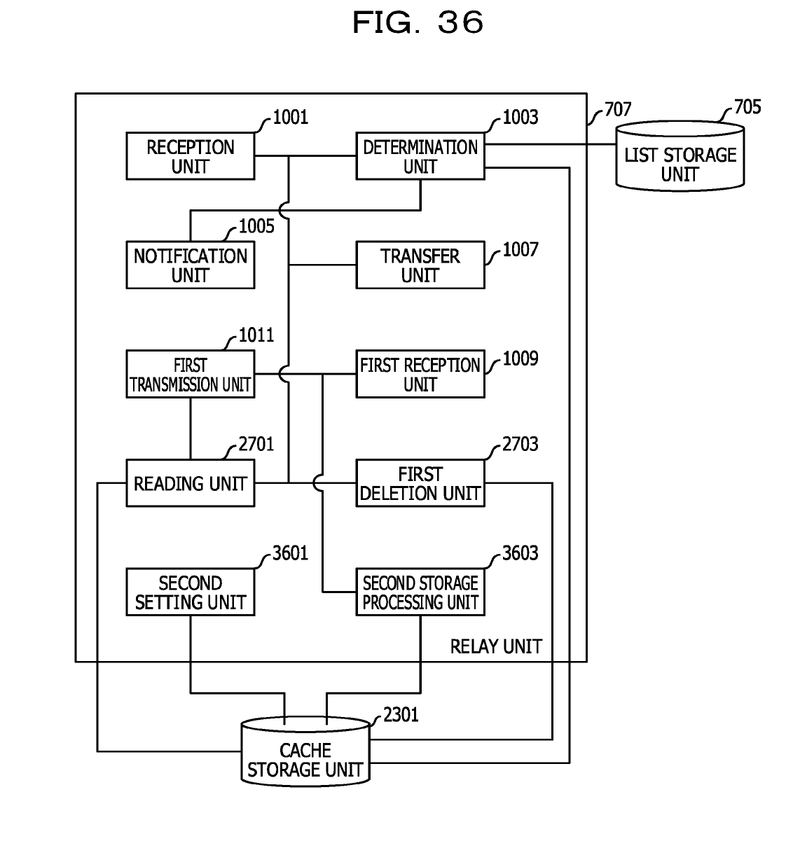

A relay unit 707 according to the fourth embodiment is described below. FIG. 36 illustrates a module configuration example of the relay unit 707 according to the fourth embodiment. The relay unit 707 according to the embodiment includes a second setting unit 3601 and a second storage processing unit 3603. The second setting unit 3601 sets “ON” or “OFF” to the above-described flag. The second storage processing unit 3603 stores the access result in the cache storage unit 2301. The second setting unit 3601 and the second storage processing unit 3603 are achieved by the hardware resources (for example, FIG. 39) and the program that causes the processor to execute the processing described below.

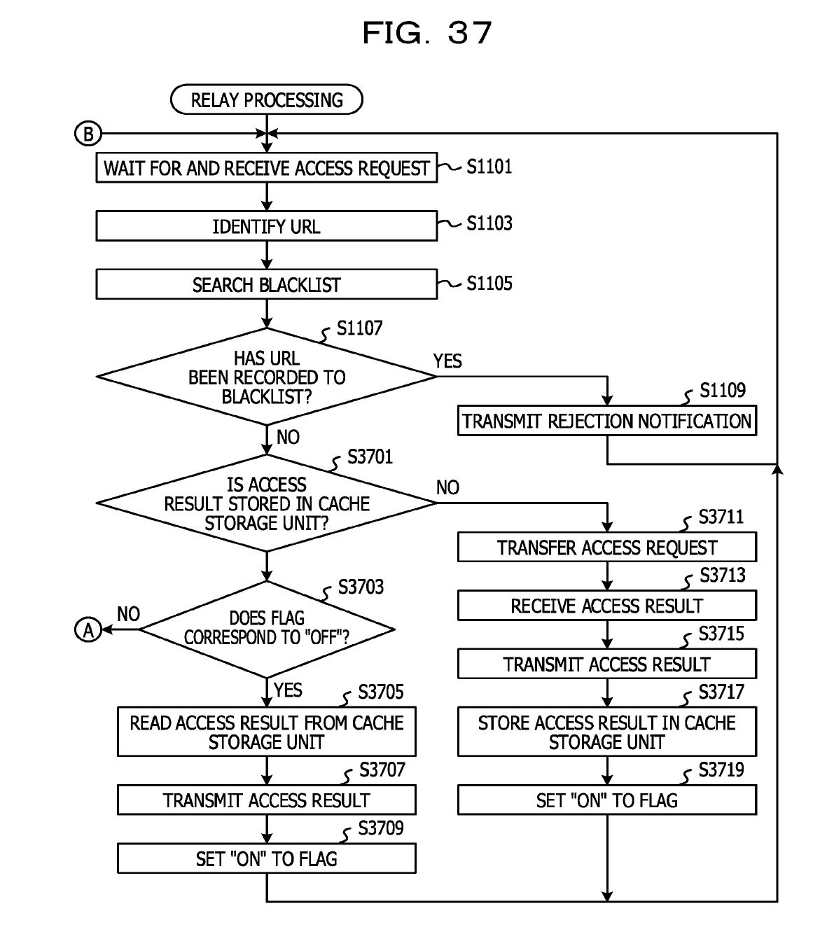

FIG. 37 illustrates an example of a relay processing flow in the fourth embodiment. Pieces of processing in S1101 to S1109 are similar to those of FIG. 11.

In S1107, when the record processing unit 809 determines that the URL that has been identified in S1103 is not included in the blacklist, the determination unit 1003 determines whether the access result corresponding to the URL that has been identified in S1103 is stored in the cache storage unit 2301 (S3701). For example, when the URL that has been identified in S1103 is stored in the cache storage unit 2301, the determination unit 1003 determines that the access result is stored in the cache storage unit 2301.

When the determination unit 1003 determines that the access result corresponding to the URL that has been identified in S1103 is stored in the cache storage unit 2301, the determination unit 1003 determines whether the flag corresponding to the URL that has been identified in S1103 corresponds to “ON” or “OFF” (S3703).

When the determination unit 1003 determines that the flag corresponding to the URL that has been identified in S1103 corresponds to “OFF”, the reading unit 2701 reads the access result corresponding to the URL that has been identified in S1103, from the cache storage unit 2301 (S3705). The first transmission unit 1011 transmits the read access result to the user terminal 103 that is the source of the access request (S3707). The second setting unit 3601 sets “ON” to the flag corresponding to the URL that has been identified in S1103 (S3709). The pieces of processing illustrated in S3705 to S3709 correspond to the sequence illustrated in FIG. 30. In addition, the flow returns to the processing of S1101, and the above-described pieces of processing are repeated.

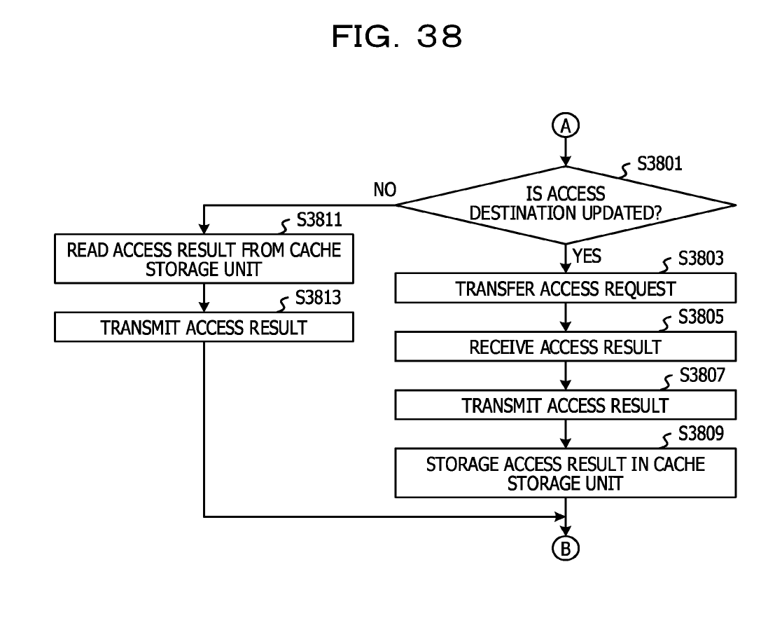

In S3703, when the determination unit 1003 determines that the flag corresponding to the URL that has been identified in S1103 corresponds to “ON”, the flow proceeds processing of S3801 illustrated in FIG. 38 through a terminal A.

The determination unit 1003 determines whether the resource of the access destination has been updated (S3801). For example, the proxy server 101 obtains an update date and time of the resource of the web server 105 that is the access destination, and compares the obtained update date and time with the previous access date and time. When the obtained update date and time is newer than the previous access date and time, the proxy server 101 determines that the web server 105 that is the access destination has been updated. In addition, when the obtained update date and time is older than the previous access date and time, the proxy server 101 determines that the web server 105 that is the access destination is not updated.

When the proxy server 101 determines that the resource of the access destination has been updated, the transfer unit 1007 transfers the access request that has been received in S1101 (S3803). The first reception unit 1009 receives an access result from the web server 105 that is the access destination (S3805). The first transmission unit 1011 transmits the received access result to the user terminal 103 that is the source of the access request (S3807). The second storage processing unit 3603 stores the access result that has been received in S3805, in the cache storage unit 2301 so as to associate the access result with the URL that has been identified in S1103 (S3809). The flag remains “ON”. The pieces of processing of S3803 to S3809 correspond to the sequence illustrated in FIG. 31. In addition, the flow returns to the processing of S1101 illustrated in FIG. 37 through a terminal B.

In addition, when the proxy server 101 determines that the resource of the access destination is not updated, the reading unit 2701 reads the access result corresponding to the URL that has been identified in S1103, from the cache storage unit 2301 (S3811). The first transmission unit 1011 transmits the read access result, to the user terminal 103 that is the source of the access request (S3813). The pieces of processing illustrated in S3811 and S3813 correspond to the sequence illustrated in FIG. 32. In addition, the flow returns to the processing of S1101 illustrated in FIG. 37 through the terminal B.

Returning to FIG. 37, in S3701, when the determination unit 1003 determines that the access result corresponding to the URL that has been identified in S1103 is not stored in the cache storage unit 2301, the transfer unit 1007 transfers the access request that has been received in S1101 (S3711). The first reception unit 1009 receives an access result from the web server 105 that is the access destination (S3713). The first transmission unit 1011 transmits the received access result, to the user terminal 103 that is the source of the access request (S3715). The second storage processing unit 3603 stores the access result that has been received in S3713, in the cache storage unit 2301 so as to associate the access result with the URL that has been identified in S1103 (S3717). The second setting unit 3601 sets “ON” to the flag corresponding to the URL that has been identified in S1103 (S3719). The sequence corresponding to the pieces of processing illustrated in S3711 to S3719 is omitted. In addition, the flow returns to the processing of S1101.

A module configuration of the mail server 109 is similar to that of the first embodiment (FIG. 12). Disclosure processing is also similar to that of the first embodiment (FIG. 13). In addition, delivery processing is also similar to that of the first embodiment (FIG. 14).

In the embodiment, the first access result that has been obtained at the time of inspection of the link destination may be sent back to the user terminal 103. For example, a failure of an access to a one-time URL is avoided.

In addition, reuse of the first access result is also avoided. For example, the purpose of a one-time URL is protected.

In addition, in a second or subsequent access, an appropriate access result may be obtained.

The embodiments are described above, but the technology discussed herein is not limited to such embodiments. For example, the above-described function block configurations may not be respectively matched with program module configurations.

In addition, the configurations of the above-described storage areas are merely examples, and the storage areas are not limited to the configurations as described above. In addition, even in each of the processing flows, processing order may be changed or the plurality of pieces of processing may be executed in parallel as long as the processing result is not changed.

In the proxy server 101 and the mail server 109 are computer devices, and as illustrated in FIG. 39, a memory 2501, a central processing unit (CPU) 2503, a hard disk drive (HDD) 2505, a display control unit 2507 coupled to a display device 2509, a drive device 2513 for a removable disk 2511, an input device 2515, and a communication controller 2517 used to be coupled to a network are coupled to each other through a bus 2519. An operating system (OS) and application programs used to execute the pieces of processing in the embodiments are stored in the HDD 2505, and executed by the CPU 2503 so as to be read from the HDD 2505 to the memory 2501. The CPU 2503 controls the display control unit 2507, the communication controller 2517, and the drive device 2513 in accordance with the processing contents of the application programs to perform a certain operation. In addition, data in the middle of processing is mainly stored in the memory 2501, but may be stored in the HDD 2505. In the embodiments, the application programs used to execute the above-described pieces of processing are stored in a computer-readable removable disk 2511, distributed, and installed to the HDD 2505 from the drive device 2513. The application program may be installed to the HDD 2505 through the network such as the Internet and the communication controller 2517. Such a computer device achieves the above-described various functions when the above-described hardware such as the CPU 2503 and the memory 2501 and the programs such as the OS and the application programs cooperate flexibly.

In the case of the proxy server 101, the computer device may include two communication controllers 2517 respectively connected to different networks.

The embodiments are described so as to be summarized below.

The information processing device according to the embodiments include an obtaining unit that obtains mail data addressed to a user, an extraction unit that extracts link data included in the mail data, an query unit that queries about pernicious of a resource indicated by the extracted link data, a recording unit that records the link data related to pernicious to a list, a reception unit that receives an access request to be transferred, from a terminal of the user, and a determination unit that determines whether an access destination of the access request corresponds to the link data related to pernicious, by referring to the list.

As a result, when the user tries to access a link destination inserted into an incoming mail, it is automatically determined that the link destination is a pernicious resource.

In addition, the above-described information processing device may include a notification unit that notifies the above-described terminal of rejection of transfer of the access request when it is determined that the access destination corresponds to the link data related to pernicious.

As a result, an access to the pernicious resource may be avoided in advance.

In addition, the above-described information processing device may include an inspection unit that inspects pernicious of the resource. In addition, the above-described query unit may query the inspection unit about pernicious of the resource.

As a result, communication cost desired for inspection of the link destination may be reduced. In addition, specific inspection criteria may be provided.

In addition, the above-described information processing device may include a storage processing unit that stores an access result obtained by an access to the resource by the inspection unit, in a storage unit. In addition, the above-described information processing device may include a transmission unit that transmits the access result stored in the above-described storage unit to the terminal when an access request to a new access destination is received and it is determined that the access destination does not correspond to the link data related to pernicious.

As a result, a first access result obtained at the time of inspection of the link destination may be sent back to the terminal of the user. For example, failure of an access to a one-time URL may be avoided.

In addition, the above-described information processing device may include a deletion unit that deletes the access result from the above-described storage unit after the access result has been transmitted to the above-described terminal.

As a result, reuse of the first access result is avoided. For example, the purpose of a one-time URL is protected.

In addition, the above-described information processing device may include a transfer unit that transfers the access request when a second or subsequent access request to an access destination is received, and it is determined that the access destination does not correspond to the link data related to pernicious. In addition, the above-described transmission unit may transmit an access result for the transferred access request, to the above-described terminal.

As a result, in the second or subsequent access, an appropriate access result may be obtained.

A program that causes a computer to execute the processing in the above-described information processing device may be created, and the program may be stored, for example, in a storage device or a computer-readable storage medium such as a flexible disk, a CD-ROM, a magneto-optical disk, a semiconductor memory, or a hard disk. An intermediate processing result may be typically stored in a storage device such as a main memory temporarily. As described above, in the technology discussed in the embodiments, it may be automatically determined that a link destination to be accessed is a pernicious resource.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
circuitry configured to:
request a mail server to provide mail data addressed to a user,
extract link data included in the mail data obtained from the mail server,
generate a list related to security of an access destination indicated by the link data,
receive an access request to the access destination, from a communication device that receives the mail data from the mail server,
determine whether the access destination is safe based on the list and the access request, and
transmit an alert regarding the security that the access destination is not safe.

2. The information processing system according to claim 1, wherein
the circuitry is configured to transfer the access request to the access destination when it is determined that the access destination is safe.

3. The information processing system according to claim 1, wherein
the circuitry is configured to inspect the security of the access destination for generating the list.

4. The information processing system according to claim 3, wherein
the circuitry is configured to access the access destination after an extraction processing of the link data, inspect the security based on an access result obtained by the access, generate the list based on a result of an inspection, and store the list into a memory.

5. The information processing system according to claim 1, wherein
the circuitry is configured to access the access destination after an extraction processing of the link data, and store an access result obtained by the access into a memory.

6. The information processing system according to claim 5, wherein
the circuitry is configured to, when it is determined that the access destination is safe, transmit the access result obtained from the memory to the communication device, in response to the access request from the communication device.

7. The information processing system according to claim 6, wherein
the circuitry is configured to delete the access result from the memory after a transmission processing of the access result to the communication device.

8. The information processing system according to claim 7, wherein
the access request is an initial access request for the access destination.

9. The information processing system according to claim 7, wherein
the circuitry is configured to transfer another access request to the access destination when the another access request is received from the communication device and it is determined that the access destination is safe, obtain another access result for the another access request, from the access destination, and transmit the another access result to the communication device.

10. The information processing system according to claim 9, wherein
the access request is an initial access request for the access destination, and
the another access request follows to the access request for the access destination.

11. An information processing method comprising:
requesting a mail server to provide mail data addressed to a user;
extracting link data included in the mail data obtained from the mail server;
generating a list related to security of an access destination indicated by the link data;
receiving an access request to the access destination, from a communication device that receives the mail data from the mail server;
determining, by circuitry, whether the access destination is safe based on the list and the access request; and
transmitting an alert regarding the security that the access destination is not safe.

12. The information processing method according to claim 11, further comprising:
transferring the access request to the access destination when it is determined that the access destination is safe.

13. The information processing method according to claim 11, further comprising:
inspecting the security of the access destination for the generating the list.

14. The information processing method according to claim 13, further comprising:
accessing the access destination after the extracting of the link data for the inspecting;
storing the list into a memory.

15. The information processing method according to claim 11, further comprising:
accessing the access destination after the extracting of the link data; and
storing an access result obtained by the accessing into a memory.

16. The information processing method according to claim 15, further comprising:
when it is determined that the access destination is safe, transmitting the access result obtained from the memory to the communication device, in response to the access request from the communication device.

17. The information processing method according to claim 16, further comprising:
deleting the access result from the memory after the transmitting of the access result to the communication device.

18. The information processing method according to claim 17, wherein
the access request is an initial access request for the access destination.

19. The information processing method according to claim 17, further comprising:
transferring another access request to the access destination when the another access request is received from the communication device and it is determined that the access destination is safe;
obtaining another access result for the another access request, from the access destination; and
transmitting the another access result to the communication device.

20. A non-transitory storage medium storing an information processing program which causes a computer to execute a process, the process comprising:
requesting a mail server to provide mail data addressed to a user;
extracting link data included in the mail data obtained from the mail server;
generating a list related to security of an access destination indicated by the link data;
receiving an access request to the access destination, from a communication device that receives the mail data from the mail server;
determining, by circuitry, whether the access destination is safe based on the list and the access request; and
transmitting an alert regarding the security that the access destination is not safe.
